(19) United States
(12) Patent Application Publication
(10) Pub. No.: US 2019/0144353 A1
(43) Pub. Date: May 16, 2019

(54) SOLID HIGH-TEMPERATURE AEROBIC FERMENTATION REACTION SYSTEM AND METHOD

(71) Applicants: Shen WANG, CHANGSHA (CN); HUNAN SAKAL ENVIRONMENTAL SCIENCE AND TECHNOLOGY CO., LTD., CHANGSHA (CN)

(72) Inventors: Shen WANG, CHANGSHA (CN); Wen KUANG, CHANGSHA (CN); Juncan WANG, CHANGSHA (CN)

(21) Appl. No.: 16/244,757

(22) Filed: Jan. 10, 2019

Related U.S. Application Data
(63) Continuation of application No. PCT/CN2016/090663, filed on Jul. 20, 2016.

(30) Foreign Application Priority Data
Jul. 11, 2016 (CN) 201610538037.9

(51) Int. Cl. C05F 17/02; C02F 3/02

(52) U.S. Cl. CPC C05F 17/0223; C05F 17/0282; C05F 17/0264; C02F 3/02

(57) ABSTRACT

A solid high-temperature aerobic fermentation reaction system includes a solid high-temperature aerobic fermentation system, a boiler system, an odor and flue gas treatment system, and a test and control system. The solid high-temperature aerobic fermentation system includes 1 to X solid high-temperature aerobic fermentation reactors. Each solid high-temperature aerobic fermentation reactor includes an inclined horizontal drum, a feed side sealing cover labyrinth sealing device, discharge side sealing cover labyrinth sealing device, a power supporting wheel set, a stirring and anti-sticking device and an integrated base. A water jacket is arranged outside the horizontal drum. The stirring and anti-sticking device is positioned in the horizontal drum which is disposed on the power supporting wheel set. The boiler system includes a shot water boiler, a circulating water pump, a three-way electric regulation valve and an electromagnetic valve.

### CROSS-REFERENCE TO RELATED APPLICATIONS

This application is a continuation of International Patent Application No. PCT/CN2016/090663 with a filing date of Jul. 20, 2016, designating the United States, now pending, and further claims priority to Chinese Patent Application No. 201610538037.9 with a filing date of Jul. 11, 2016. The content of the aforementioned applications, including any intervening amendments thereto, are incorporated herein by reference.

### TECHNICAL FIELD

The present disclosure belongs to the technical field of biological fermentation, and particularly relates to a solid high-temperature aerobic fermentation reaction system and method used for reductive, harmless and recycling treatment of feces, sludge and garbage.

### BACKGROUND OF THE PRESENT INVENTION

Major by-products of large-scale livestock, and poultry farms, sewage treatment plants and residential areas, i.e., feces, sludge and kitchen garbage (collectively referred to as organic waste or fermentation raw materials) are in large quantity and are highly centralized. If the by-products cannot be disposed effectively in time, it is easy to cause serious environmental pollution.

In aerobic fermentation (composting), organic matters may be degraded through microorganisms to realize reducing, harmlessness and recycling treatment for organic waste. A field composting fermentation technology widely used at present mainly has a series of problems of large occupation area, long fermentation time (generally, it takes about 15-30 days for primary fermentation), reduction and even stop of the fermentation speed in low-temperature weather, difficulty in collection and treatment of odor which pollutes the environment and the like. Trough composting is mostly researched at present, and aims to improve the efficiency or effect of aerobic composting through ventilation and forced oxygen feeding, turning or stirring and the like. This mode has the problems of high investment cost for infrastructures and turning equipment and severe secondary pollution caused by heat and odor which are produced by fermentation and generally allowed to be discharged into the atmosphere. A famous Dano drum type aerobic reactor has the features of high fermentation efficiency, small occupation area and the like relative to site fermentation, but a fermentation effect depends on factors such as the length of a drum. To prolong the retention time of fermentation raw material in the drum reactor to guarantee the fermentation effect, the length of the drum is generally designed to be 10 times and even 20 times or more the diameter of the drum, so that the occupation area is still very large, and the equipment manufacturing cost is high. Meanwhile, the aerobic reactor also has the defects of extremely small contact area between newly added fermentation raw material (organic waste) and the fermentation raw material, relatively low reaction speed caused by insufficiency of zymophyte of the newly added fermentation raw material and the like.

At present, rotating drum reactor fermentation equipment often adopts a shoveling plate device arranged on an inner wall surface of a drum, and increases the contact area between air and materials through a turning effect of a shoveling plate, so as to increase aerobic fermentation efficiency. However, the shoveling plate is easy to adhere to the wall, thereby not only reducing fermentation efficiency and affecting discharge, but also increasing the load of driving a drum rotating motor and increasing energy consumption.

In the fermentation and composting process of the organic waste, under aerobic or anoxic conditions, organic components in the materials such as protein are decomposed by microorganisms, producing a large number of toxic and harmful odor gases. If the odor is not treated and is discharged directly into the atmosphere, the atmospheric environment of composting plants and surroundings will be seriously affected. Therefore, deodorization engineering in the composting process becomes an indispensable part of high-temperature composting process of organic solid waste. In the fermentation process of the organic waste, the microorganisms oxidize part of organic matter into simple inorganic matter through metabolic activities to provide energy required for the life activities of living creatures, and converts another part of the organic matter into nutrients needed by the organisms to form new cell bodies and make the microorganisms continuously proliferated. In this process, a large amount of energy is released, and except for a small part of energy that provides energy for cytoplasmic synthesis, the rest of the energy is released in the form of heat. According to the literature, in the high-temperature fermentation stage of the organic waste, the heat produced by oxidation and decomposition of the organic waste by the microorganisms is about 420 kJ/kg. The heat energy is discharged with the odor, making the odor temperature up to 60-70° C. Meanwhile, because the temperature of a material stack is increased, the evaporation speed of material moisture is accelerated and a large amount of moisture is also discharged with the odor.

In the fermentation and composting process of the organic waste in a reactor, in order to increase the fermentation efficiency, shorten the composting time and improve the quality of organic fertilizers, heat sources are often set to heat the reactor, such as coal, diesel oil and biomass fuel for combustion. However, in the process of combustion, these heat sources inevitably produce particulate matter such as soot, and toxic and harmful gases such as carbon monoxide (CO), sulfur dioxide (SO₂) and nitrogen oxides (NOₓ), causing serious air and environment pollution, producing a series of environmental problems such as acid rain, greenhouse effect and haze, and bringing a great negative impact on human production and life. It is of great practical significance to treat flue gas produced in the combustion process of the heat sources and avoid secondary pollution while treating the pollution of the organic solid waste.

There are many technologies to treat odor and organic odor, such as absorption, incineration, chemical conversion, condensation and biological methods. However, in these methods, the most economical and effective method is a biological deodorization method. The biological deodorization method is an odorless and innocuous process which uses microbial flora with deodorization function to convert hydrogen sulfide in the odor and reduce sulfide and other odor substances, and has the advantages of high removal rate, low operating cost, simple operation and management and no secondary pollution. However, the deodorization effect of the biological deodorization method depends on the activity of deodorization microorganisms. Too high or too low deodorization inlet temperature will affect the growth and reproduction of the microorganisms, thereby reducing the deodorization effect. When the deodorization inlet temperature is higher than 40° C. or lower than 15° C., the growth and reproduction of the deodorization microorganisms are inhibited; and when the deodorization inlet temperature is higher than 60° C., a large number of deodorization microorganisms die and the deodorization effect is lost.

A Chinese patent CN 102617204A discloses an efficient and intelligent aerobic fermentation reaction system. A shoveling plate is disposed in a drum of an aerobic fermentation reactor. The patent has the disadvantage that after the shoveling plate is used for a period of time, a large number of materials are adhered to the shoveling plate, thereby not only affecting fermentation and discharge efficiency, but also increasing energy consumption. In the patent, a method of driving a large gear by a small gear is adopted for rotating drive of the reactor. However, the large gear has high cost and high requirements for installation accuracy. In addition, the patent does not mention a sealing problem of a rotating drum and a fixed end cover. Improper sealing is high in cost, easy to produce leakage and troublesome in maintenance. The patent also does not mention the treatment of fermentation odor and combustion flue gas of auxiliary heat sources.

### SUMMARY OF PRESENT INVENTION

The purpose of the present disclosure is to solve the problems in the above background, so as to provide a solid high-temperature aerobic fermentation reaction system and method used for reductive, harmless and recycling treatment of feces, sludge, garbage and other pollutants and having the advantages of small occupation area, no possibility of being influenced by environmental factors and low temperature conditions, high fermentation efficiency, no production of secondary pollution, no odor and heat emission, good environmental protection effect and wide application range.

The present disclosure adopts the following technical solution: a solid high-temperature aerobic fermentation reaction system includes a solid high-temperature aerobic fermentation system, a boiler system, an odor and flue gas treatment system and a test and control system. The solid high-temperature aerobic fermentation system includes 1 to X solid high-temperature aerobic fermentation reactors, wherein X is more than or equal to 1. Each solid high-temperature aerobic fermentation reactor includes an inclined horizontal drum, a feed side sealing cover labyrinth sealing device, a discharge side sealing cover labyrinth sealing device, a power supporting wheel set, a stirring and anti-sticking device and an integrated base. A water jacket is arranged outside the horizontal drum. The feed side is higher than the discharge side. The horizontal drum, the feed side sealing cover labyrinth sealing device and the discharge side sealing cover labyrinth sealing device form a closed fermentation space. A feed hole and an exhaust hole are formed in the upper part of the feed side sealing cover. An air inlet hole is formed in the upper part of the discharge side sealing cover. A discharge hole is formed in the lower part of the discharge side sealing cover. A discharge gate is installed on the discharge hole. The stirring and anti-sticking device is positioned in the horizontal drum which is disposed on the power supporting wheel set. The power supporting wheel set, the feed side sealing cover and the discharge side sealing cover are fixed to the integrated base. The boiler system includes a hot water boiler, a circulating water pump, a three-way electric regulation valve and an electromagnetic valve. A water outlet of the boiler system is connected with the jacket of the solid high-temperature aerobic fermentation reactor. The odor and flue gas treatment system includes an odor heat exchange condenser, a flue gas heat exchange condenser, a biological deodorization filtering tower, an induced draft fan and an electromagnetic valve. The exhaust hole of the solid high-temperature aerobic fermentation reactor and a smoke vent of the hot water boiler are connected with the odor and flue gas treatment system. The test and control system is as follows: temperature sensors are installed on a water outlet pipeline and a water return pipeline of the hot water boiler; a material temperature sensor is disposed in the solid high-temperature aerobic fermentation reactor; material level sensors for confirming material positions are disposed on loading and unloading conveying equipment, a feed port and a discharge port; detection signals of the above sensors are input into an input end of a controller; and an output end of the controller controls the boiler system, the odor and flue gas treatment system, the solid high-temperature aerobic fermentation reactor and the external loading and unloading conveying equipment.

In the above technical solution, the water jacket outside the horizontal drum is divided into a plurality of parts by a rolling ring. The a plurality of parts are connected into a whole through a water jacket connection, pipe. The water jacket is led to the axis of a horizontal drum sealing cover through a water jacket extraction pipe and is connected with an external circulating water pipe through a rotating joint installed at the axis of the sealing cover. A heat preservation layer covers the outer surface of the water jacket arranged outside the horizontal drum and is made of heat preservation and isolation material, such as stone wool, polyurethane and asbestos.

In the above technical solution, at least four or more power supporting wheel sets are disposed, and every two power supporting wheel sets are symmetrically distributed on both sides of the bottom of the horizontal drum. The quantity of the power supporting wheel sets is determined according to the length of the drum. Each of the power supporting wheel sets also includes a supporting wheel, a power driving device and a base. The power driving device structurally includes a motor, a speed reducer and a shaft coupler which are connected successively, or a motor, a speed reducer, a chain transmission device or a belt transmission device which are connected successively. The power driving device and supporting wheels are in transmission connection. Each of the supporting wheels is a driving wheel that drives the horizontal drum to rotate, so as to control the supporting wheels to coordinate and drive the horizontal drum to rotate.

In the above technical solution, the structure and the principle of the feed side sealing cover labyrinth sealing device are completely the same as those of the discharge side sealing cover labyrinth sealing device, and each of the structures is that a lining ring having a radial plane consistent with the horizontal drum is fixed to an inner wall of the drum at a certain distance from the end of the horizontal drum. The outer circumference of the lining ring and the inner wall of the horizontal drum are consistent and are fixedly connected. A lining ring hood axially identical with the horizontal drum is fixedly installed on the lining ring. Correspondingly, two, concentric sealing cover hoods are vertically welded on the inner side plane of the sealing cover: a sealing cover outer hood and a sealing cover inner hood. The sealing cover inner hood is positioned on the inner side of the sealing cover outer hood, the sealing cover outer hood is sleeved on the outer side of the end of the horizontal drum, and the sealing cover inner hood is sleeved between the inner wall of the horizontal drum and the lining ring hood. Meanwhile, the following three heights are required to be consistent: the height of the lining ring hood, the height of the sealing cover inner hood and a distance from the lining ring to the end of the horizontal drum. Waist-shaped hole grooves are disposed in a feed side sealing cover and a discharge side sealing cover. Clearances from the feed side sealing, cover and the discharge side sealing cover to the horizontal drum are adjusted by adjusting relative positions of the waist-shaped hole grooves in the feed side sealing cover and the discharge side sealing cover and an integrated base, so as to avoid material leakage from gaps among the feed side sealing cover, the discharge side sealing cover and both ends of the horizontal drum. The labyrinth sealing device is innovated and designed according to the special working condition and special device of the horizontal drum of the solid high-temperature aerobic fermentation reactor. Obviously, this large spiral rolling device is not suitable for being sealed by a rubber seal ring. The labyrinth sealing effect of the present disclosure is guaranteed by gaps between the inner sides of the sealing covers and the end surface of the drum. If the gaps between the inner sides of the sealing covers and the end surfaces of the drum are smaller, fewer materials are leaked, so that the positions of the end covers on both sides are adjusted to allow the drum to rotate flexibly, so as to achieve a sealing effect of least leakage.

In the above technical solution, according to the length of the horizontal drum, the stirring and anti-sticking device may be composed of one or more cage-shaped structures. When the horizontal drum is relatively short, the stirring and anti-sticking device may be composed of only one cage-shaped structure. When the horizontal drum is relatively long, the stirring and anti-sticking device may be composed of a plurality of cage-shaped structures. Each of the cage-shaped structures is composed of two coaxial supporting plates and a plurality of shoveling plates. The supporting plates are circular rings, and both ends of each of the plurality of shoveling plates are respectively connected and fixed with the two coaxial supporting plates. Correspondingly, contact blocks are disposed on the inner wall of the horizontal drum.

In the above technical solution, the axis of the cage-shaped structure is at a side of the axis of the horizontal drum, and does not coincide with the axis of the horizontal drum. Namely, the cage-shaped structure is installed in a mode of deviating from the axis in the horizontal drum.

In the above technical solution, the movement of a fermentation raw material from the feed side to the discharge side in the horizontal drum may be realized through a certain angle formed between the horizontal drum and a horizontal plane, and also may be realized through spiral shapes formed by certain inclined angles between the shoveling plates of the stirring and anti-sticking device and the axis of the horizontal drum and anticlockwise rotation of the horizontal drum.

In the above technical solution, a plurality of shoveling plates are parallel to the axis of the cage-shaped structure, or a plurality of shoveling plates form inclined angles with the axis of the cage-shaped structure, or a plurality of shoveling plates are curve shapes. When the horizontal drum performs spiral rotation, the contact block on the inner wall drives a stirring and anti-sticking device to rotate. When the shoveling plates of the stirring and anti-sticking device are parallel to the axis, because the shoveling plates have a certain width, the stirring and anti-sticking device drives the material on the bottom in the horizontal drum to move upward and the material is thrown down from the shoveling plates under the action of self-gravity and falls on the bottom of the horizontal drum, so as to play a role of throwing the material. When the shoveling plates of the stirring and anti-sticking device form certain angles with the axis, the material in the drum moves towards one direction, so as to play a role of guiding the material besides the role of throwing the material.

In the above technical solution, an included angle of 0-5 degrees formed between the integrated base and the horizontal plane is adjustable. The drum slantways lies down by adjusting the included angle, so as to adjust the conveying speed of the fermentation raw material to the discharge end.

In the above technical solution, a stop wheel is also disposed on the integrated base. The stop wheel is connected to the integrated base in a bolting manner. A waist-shaped hole groove is formed in a stop wheel seat. The stop wheel is adjusted through the waist-shaped hole groove so as to come into contact between the stop wheel and the side line of the rolling ring. The stop wheel keeps off an axial component force of the horizontal drum, so as to prevent the drum from moving along the axis.

In the above technical solution, the water outlet pipeline of the hot water boiler is connected to the input end of the three-way electric regulation valve. Two output ends of the three-way electric regulation valve are respectively connected with an in-parallel solid high-temperature aerobic fermentation reactor water inlet flange through the water outlet pipeline. An electromagnetic valve is connected to the water outlet pipeline of each solid high-temperature aerobic fermentation reactor. The water outlet end of the electromagnetic valve is connected with the water return pipeline of the hot water boiler. The water return pipeline is provided with a circulating water pump to enable circulating water to form a loop.

In the above technical solution, in the high-temperature aerobic fermentation reaction process, the control system automatically controls the opening of the circulating water three-way electric regulation valve according to the temperatures of the materials in the solid high-temperature aerobic fermentation reactors, so that the temperatures of the fermentation materials are stabilized at a set temperature all the time. When the temperature of the material in the solid high-temperature aerobic fermentation reactor of the first fermentation object is less than the set value, the opening of the three-way electric regulation valve in this loop is 100%, and the openings in the loops of other solid high-temperature aerobic fermentation reactors are 0. When the temperature of the material in the solid high-temperature aerobic fermentation reactor of the first fermentation object is close to the set value, the control system controls to turn on the electromagnetic valve in the circulating water loop of the solid high-temperature aerobic fermentation reactor of the second fermentation object, and the three-way electric regulation valve performs PID regulation to allow part of the hot circulating water to flow through the solid high-temperature aerobic fermentation reactor of the second fermentation object, so that the material in the solid high-temperature aerobic fermentation reactor of the second fermentation object is heated under the condition of stabilizing the temperature of the material in the solid high-temperature aerobic fermentation reactor of the first fermentation object at the set value. Because the aerobic fermentation process is a heat release process, along with the fermentation, the temperatures of the materials in the solid high-temperature aerobic fermentation reactors continuously rise up. When the temperature of the material in the solid high-temperature aerobic fermentation reactor of the first fermentation object is greater than the set value, the control system slows down or shuts off the heating of the hot water boiler. Under the action of the circulating pump, the circulating water of the solid high-temperature aerobic fermentation reactor of the first fermentation object is mixed with the circulating water of the solid high-temperature aerobic fermentation reactor of the second fermentation object, resulting in that the temperature of the material in the solid high-temperature aerobic fermentation reactor of the first fermentation object is reduced, and the temperature of the material in the solid high-temperature aerobic fermentation reactor of the second fermentation object is increased. The three-way electric regulation valve and the electromagnetic valve are coordinately controlled by the control system to convey fermentation reaction heat of the previous solid high-temperature aerobic fermentation reactor and heat generated by heating of the boiler to the second or Xth solid high-temperature aerobic fermentation reactor, so that the temperatures of the materials in the solid high-temperature aerobic fermentation reactors may be stabilized at the set value, and the heat energy generated by the fermentation reaction may be recycled.

In the above technical solution, a pressure water tank is connected with a water supplementing pipe through a valve, and the other end of the water supplementing pipe is connected with the hot water boiler. The pressure water tank is connected with an external water supply pipe through a water supplementing valve and is configured to supplement water to a circulating water system.

Further, an exhaust valve and a pressure gauge are installed on the water inlet pipeline of the circulating water pump. When air is included in the circulating water system, the air may be discharged through the exhaust valve.

In the above technical solution, the solid high-temperature aerobic fermentation reactor exhaust hole is connected with the heat exchange air inlet of the odor heat exchange condenser through the pipeline. The heat exchange air outlet of the odor heat exchange condenser is connected with the input end of the induced draft fan through the pipeline, and the output end of the induced draft fan is connected with the air inlet of the biological deodorization filtering tower through the air inlet pipeline. A temperature sensor is installed on a main-path air inlet pipeline of the biological deodorization filtering tower. Odor exhausted by the solid high-temperature aerobic fermentation reactor is cooled by the odor heat exchange condenser, absorbed and converted by the biological deodorization filtering tower, and is discharged after reaching the standard. The air inlet of the odor heat exchange condenser is connected with atmosphere, and an air outlet is connected with the solid high-temperature aerobic fermentation reactor air inlet hole. After cold air is heated by the odor heat exchange condenser, the solid high-temperature aerobic fermentation reactor is aerated through the induced draft fan. The smoke vent of the hot water boiler is connected with the heat exchange air inlet of the flue gas heat exchange condenser through the pipeline. The heat exchange air outlet of the flue gas heat exchange condenser is connected with the input end of the induced draft fan, and the output end of the induced draft fan is connected with the air inlet of the biological deodorization filtering tower. Flue gas exhausted by the hot water boiler is cooled by the flue gas heat exchange condenser, absorbed and converted by the biological deodorization filtering tower, and is discharged after reaching the standard. The air inlet of the flue gas heat exchange condenser is connected with atmosphere, and an air outlet is connected with an air inlet of an air blower of the hot water boiler, so as to provide fresh hot air for the hot water boiler.

In the above technical solution, condensed water produced by heat exchange between hot odor and flue gas and cold air in the odor heat exchange condenser and the flue gas heat exchange condenser is drained into a natural ditch through the odor heat exchange condenser and the flue gas heat exchange condenser via pipelines.

Further, the air inlet pipeline of the odor heat exchange condenser is provided with an electromagnetic valve and a bypass branch. The bypass branch of the odor heat exchange condenser is provided with an electromagnetic valve. When detecting that the odor temperature detected by the temperature sensor installed on the main-path air inlet pipeline of the biological deodorization filtering tower is more than 40° C., the control system turns on the electromagnetic valves on the air inlet pipeline of the odor heat exchange condenser and turns off the electromagnetic valves of the bypass branches to allow the odor entering the biological deodorization filtering tower to be cooled by the odor heat exchange condenser. When detecting that the odor temperature detected by the temperature sensor installed on the main-path air inlet pipeline of the biological deodorization filtering tower is less than 15° C., the control system turns off the electromagnetic valves on the air inlet pipeline of the odor heat exchange condenser and turns on the electromagnetic valves of the bypass branches to forbid the odor to enter the odor heat exchange condenser for cooling. Therefore, the biological deodorization filtering tower works in a temperature range between 15° C. and 40° C., so as to guarantee the deodorization effect and prevent dormancy and death of microorganisms in the biological deodorization filtering tower.

In the above technical solution, in the test and control system, the temperature sensors are disposed on the water outlet pipeline and the water return pipeline of the hot water boiler; the outputs of the temperature sensors are connected with the control system; the material temperature sensor is disposed in the aerobic fermentation reactor; the output of the material temperature sensor is connected with the control system; the material level sensors for confirming material positions are disposed on the loading and unloading conveying equipment, the feed port and the discharge port; and the outputs of the material level sensors are connected with the control system.

An aerobic fermentation method based on the above solid high-temperature aerobic fermentation reaction system includes that:

(1) a solid high-temperature aerobic fermentation reaction system is built, which includes a solid high-temperature aerobic fermentation system, a boiler system, an odor and flue gas treatment system and a test and control system; the solid high-temperature aerobic fermentation system includes 1 to X solid high-temperature aerobic fermentation reactors, and X is more than or equal to 1; each solid high-temperature aerobic fermentation reactor includes an inclined horizontal drum, a feed side sealing cover labyrinth sealing device, a discharge side sealing cover labyrinth sealing device, a power supporting wheel set, a stirring and anti-sticking device and an integrated base; a water jacket is arranged outside the horizontal drum; the feed side is higher than the discharge side; the horizontal drum, the feed side sealing cover labyrinth sealing device and the discharge side sealing cover labyrinth sealing device form a closed fermentation space; a feed hole and an exhaust hole are formed in the upper part of the feed side sealing cover; an air inlet hole is formed in the upper part of the discharge side sealing cover; a discharge hole is formed in the lower part of the discharge side sealing cover; a discharge gate is installed on the discharge hole; the stirring and anti-sticking device is positioned in the horizontal drum which is disposed on the power supporting wheel set; the power supporting wheel set, the feed side sealing cover and the discharge side sealing cover are fixed to the integrated base to form a whole; the boiler system includes a hot water boiler, a circulating water pump, a three-way electric regulation valve and an electromagnetic valve; the boiler system is connected with the jacket of the solid high-temperature aerobic fermentation reactor; the odor and flue gas treatment system includes an odor heat exchange condenser, a flue gas heat exchange condenser, a biological deodorization filtering tower, an induced draft fan and an electromagnetic valve; the exhaust hole of the solid high-temperature aerobic fermentation reactor and a smoke vent of the hot water boiler are connected with the odor and flue gas treatment system. The test and control system is as follows: temperature sensors are installed on a water outlet pipeline and a water return pipeline of the hot water boiler; a material temperature sensor is disposed in the solid high-temperature aerobic fermentation reactor; material level sensors for confirming material positions are disposed on loading and unloading conveying equipment, a feed port and a discharge port; detection signals of the above sensors are input into an input end of a controller; and an output end of the controller controls the boiler system, the odor and flue gas treatment system, the solid high-temperature aerobic fermentation reactor and the external loading and unloading conveying equipment;

(2) the structure and the principle of the feed side sealing cover labyrinth sealing device are completely the same as those of the discharge side sealing cover labyrinth sealing device, and each of the structures is that a lining ring having a radial plane consistent with the horizontal drum is fixed to an inner wall of the drum at a certain distance from the end of the horizontal drum; the outer circumference of the lining ring and the inner diameter of the horizontal drum are consistent and are fixedly connected; a lining ring hood axially identical with the horizontal drum is fixedly installed on the inner circumference of the lining ring; correspondingly, two concentric sealing cover hoods are vertically welded on the inner side plane of the sealing cover: a sealing cover outer hood and a sealing cover inner hood; the sealing cover inner hood is positioned on the inner side of the sealing cover outer hood, the sealing cover outer hood is sleeved on the outer side of the end of the horizontal drum, and the sealing cover inner hood is sleeved between the inner wall of the horizontal drum and the lining ring hood; meanwhile, the following three heights are required to be consistent: the height of the lining ring hood, the height of the sealing cover inner hood and a distance from the lining ring to the end of the horizontal drum; waist-shaped hole grooves are disposed in a feed side sealing cover and a discharge side sealing cover; clearances from the feed side sealing cover and the discharge side sealing cover to the horizontal drum are adjusted by adjusting relative positions of the waist-shaped hole grooves in the feed side sealing cover and the discharge side sealing cover and an integrated base, so as to avoid material leakage from gaps among the feed side sealing cover, the discharge side sealing cover and both ends of the horizontal drum; more further, the quantity of the inner hoods is increased at the inner sides of the sealing covers; correspondingly, the quantity of the ring hoods is increased at the inner side of the drum to increase the quantity of labyrinths, so as to increase the length of the labyrinths and reduce material leakage;

(3) according to the length of the, horizontal drum, the stirring and anti-sticking device may be composed of one or more cage-shaped structures; when the horizontal drum is relatively short, the stirring and anti-sticking device may be composed of only one cage-shaped structure; when the horizontal drum is relatively long, the stirring and anti-sticking device may be composed of a plurality of cage-shaped structures; each of the cage-shaped structures is composed of two coaxial supporting plates and a plurality of shoveling plates; the supporting plates are circular rings, and both ends of each of the plurality of shoveling plates are respectively connected and fixed with the two coaxial supporting plates; correspondingly, contact blocks are disposed on the inner wall of the horizontal drum; the axis of the cage-shaped structure is at a side of the axis of the horizontal drum, and does not coincide with the axis of the horizontal drum; namely, the cage-shaped structure is installed in a mode of deviating from the axis in the horizontal drum;

(4) the water outlet pipeline of the hot water boiler is connected to the input end of the three-way electric regulation valve; two output ends of the three-way electric regulation valve are respectively connected with an in-parallel solid high-temperature aerobic fermentation reactor water inlet flange through the water outlet pipeline; an electromagnetic valve is connected to the water outlet pipeline of each solid high-temperature aerobic fermentation reactor; the water outlet end of the electromagnetic valve is connected with the water return pipeline of the hot water boiler; the water return pipeline is provided with a circulating water pump to enable circulating water to form a loop;

(5) the solid high-temperature aerobic fermentation reactor exhaust hole is connected with the heat exchange air inlet of the odor heat exchange condenser through the pipeline; the heat exchange air outlet of the odor heat exchange condenser is connected with the input end of the induced draft fan through the pipeline, and the output end of the induced draft fan is connected with the air inlet of the biological deodorization filtering tower through the air inlet pipeline; a temperature sensor is installed on a main-path air inlet pipeline of the biological deodorization filtering tower; odor exhausted by the solid high-temperature aerobic fermentation reactor is cooled by the odor heat exchange condenser, absorbed and converted by the biological deodorization filtering tower, and is discharged after reaching the standard; the air inlet of the odor heat exchange condenser is connected with atmosphere, and an air outlet is connected with the solid high-temperature aerobic fermentation reactor air inlet hole; after cold air is heated by the odor heat exchange condenser, the solid high-temperature aerobic fermentation reactor is aerated through the induced draft fan; the smoke vent of the hot water boiler is connected with the heat exchange air inlet of the flue gas heat exchange condenser through the pipeline; the heat exchange air outlet of the flue gas heat exchange condenser is connected with the input end of the induced draft fan, and the output end of the induced draft fan is connected with the air inlet of the biological deodorization filtering tower; flue gas exhausted by the hot water boiler is cooled by the flue gas heat exchange condenser, absorbed and converted by the biological deodorization filtering tower, and is discharged after reaching the standard; the air inlet of the flue gas heat exchange condenser is connected with atmosphere, and an air outlet is connected with an air inlet of an air blower of the hot water boiler, so as to provide fresh hot air for the hot water boiler;

(6) the boiler system is started; the hot water boiler heats the circulating water; the circulating hot water enters an external water jacket of the solid high-temperature aerobic fermentation reactor, so that the solid high-temperature aerobic fermentation reactor is heated and the circulating water is heated to a set temperature suitable for high-temperature aerobic fermentation;

(7) external conveying equipment is started; fermentation raw materials and accessories, and a high-temperature aerobic bacteria are fed into the solid high-temperature aerobic fermentation reactor through the conveying equipment;

(8) during feeding, the control system starts all power driving devices at the same time to allow all power supporting wheel sets to rotate at the same time to drive a horizontal drum of the solid high-temperature aerobic fermentation reactor to rotate forwards; by virtue of the action of the stirring and anti-sticking device in the solid high-temperature aerobic fermentation reactor, fermentation raw materials are conveyed to the discharge side, and organic waste is shoveled up and dropped down so that the organic waste is fully stirred and mixed with oxygen, thereby enlarging the contact area of the fermentation raw materials and the oxygen;

(9) the boiler and the odor and flue gas treatment system are started at the same time; odor exhausted by the solid high-temperature aerobic fermentation reactor is cooled by the odor heat exchange condenser, then is conveyed to the biological deodorization filtering tower for absorption and conversion and is discharged into the atmosphere through the exhaust port of the biological deodorization filtering tower after reaching the standard; flue gas exhausted by the hot water boiler exchanges heat through the flue gas heat exchange condenser, is led to the biological deodorization filtering tower through the induced draft fan, then is absorbed and converted through the biological deodorization filtering tower and is discharged into the atmosphere through the exhaust port of the biological deodorization filtering tower after reaching the standard; meanwhile, fresh air heated by the flue gas heat exchange condenser is blasted into hot water boiler through an air blower of the hot water boiler to provide fresh hot air for the hot water boiler; condensed water produced by heat exchange between hot odor, and flue gas and cold air in the odor heat exchange condenser and the flue gas heat exchange condenser is drained into a natural ditch through the odor heat exchange condenser and the flue gas heat exchange condenser via pipelines;

(10) when the amount of organic waste raw materials which are conveyed into the solid high-temperature aerobic fermentation reactor achieves the requirement, the control system controls to stop feeding;

(11) in the high-temperature aerobic fermentation reaction process, the control system automatically controls the opening of the circulating water three-way electric regulation valve according to the temperatures of the materials in the solid high-temperature aerobic fermentation reactors, so that the temperatures of the fermentation materials are stabilized at a set temperature all the time; when the temperature of the material in the solid high-temperature aerobic fermentation reactor of the first fermentation object is less than the set value, the opening of the three-way electric regulation valve in, this loop is 100%, and the openings in the circulating water loops of other solid high-temperature aerobic fermentation reactors are 0; when the temperature of the material in the solid high-temperature aerobic fermentation reactor of the first fermentation object is close to the set value, the control system controls to turn on the electromagnetic valve in the circulating water loop of the solid high-temperature aerobic fermentation reactor of the second fermentation object, and the three-way electric regulation valve performs PID regulation to allow part of the hot circulating water to flow through the water jacket of the second solid high-temperature aerobic fermentation reactor, so that the second solid high-temperature aerobic fermentation reactor is heated under the condition of stabilizing the temperature of the material in the solid high-temperature aerobic fermentation reactor of the first fermentation object at the set value; because the aerobic fermentation process is a heat release process, along with the fermentation, the temperatures of the materials in the solid high-temperature aerobic fermentation reactors continuously rise up; when the temperature of the material in the solid high-temperature aerobic fermentation reactor of the first fermentation object is greater than the set value, the control system slows down or shuts off the heating of the hot water boiler; under the action of the circulating pump, the circulating water of the solid high-temperature aerobic fermentation reactor of the first fermentation object is mixed with the circulating water of the solid high-temperature aerobic fermentation reactor of the second fermentation object, resulting in that the temperature of the material in the solid high-temperature aerobic fermentation reactor of the first fermentation object is reduced, and the, temperature of the material in the solid high-temperature aerobic fermentation reactor of the second fermentation object is increased; the three-way electric regulation valve and the electromagnetic valve are coordinately controlled by the control system to convey fermentation reaction heat of the previous solid high-temperature aerobic fermentation reactor and heat generated by heating of the hot water boiler to the second or Xth solid high-temperature aerobic fermentation reactor, so that the temperatures of the materials in the solid high-temperature aerobic fermentation reactors may be stabilized at the set value, and the heat energy generated by the fermentation reaction may be recycled;

(12) in an aerobic fermentation reaction process, the control system controls the power driving device of the solid high-temperature aerobic fermentation reactor to operate in a periodic intermittent operation manner of backward rotation-stop-backward rotation-stop . . . according to a detected temperature of the fermentation raw material; for shoveling plates of the stirring and anti-sticking device, during rotation of the drum, the stirring and anti-sticking device drives the materials at the bottom of the horizontal drum to move upwards, and the materials are separated from the shoveling plates under the action of the gravity of the materials and are thrown away and dropped back to the bottom of the horizontal drum, so as to achieve stirring and air contact effects; by virtue of the action of the spiral shoveling plates in the solid high-temperature aerobic fermentation reactor, the backward rotating drum shovels up the materials and conveys the fermentation raw materials to the feed side, so that the fermentation materials may not be compacted on the discharge side sealing cover; meanwhile, the fermentation raw materials may not be adhered to the inner wall of the drum of the solid high-temperature aerobic fermentation reactor, and the energy consumption caused by stirring and heat conduction is minimized;

(13) when detecting that the odor temperature detected by the temperature sensor installed on the main-path air inlet pipeline of the biological deodorization filtering tower is more than 40° C., the control system turns on the electromagnetic valves on the air inlet pipeline of the odor heat exchange condenser and turns off the electromagnetic valves of the bypass branches to allow the odor entering the biological deodorization filtering tower to be cooled by the odor heat exchange condenser; when detecting that the odor temperature detected by the temperature sensor installed on the main-path air inlet pipeline of the biological deodorization filtering tower is less than 15° C., the control system turns off the electromagnetic valves on the air inlet pipeline of the odor heat exchange condenser and turns on the electromagnetic valves of the bypass branches to forbid the odor to enter the odor heat exchange condenser for cooling; therefore, the biological deodorization filtering tower works in a temperature range between 15° C. and 40° C., so as to guarantee the deodorization effect and prevent dormancy or death of microorganisms in the biological deodorization filtering tower;

(14) when one solid high-temperature aerobic fermentation reactor completes the high-temperature aerobic fermentation reaction, the control system controls to turn off electromagnetic valves at the front ends of the power driving device and a water inlet pipeline of the water jacket of the solid high-temperature aerobic fermentation reactor, and controls to turn on a discharge gate at the same time; then the control system controls the power driving device to continuously rotate forwards to discharge part of old fermentation materials to the next working procedure for treatment through external conveying equipment; and

(15) the above steps are repeated so that the biological fermentative degradation reaction of the organic waste is circulated at high speed.

The stirring and anti-sticking device arranged in the horizontal drum of the present disclosure has the material throwing effect and may prevent the materials in the drum from being adhered to the inner wall of the drum. When the shoveling plates of the stirring and anti-sticking device and the axis of the stirring and anti-sticking device form a certain angle, a material guide effect is also achieved. In case of damage, the stirring and anti-sticking device may be removed for maintenance or replacement and is convenient to use and maintain.

In the present disclosure, the labyrinth sealing devices are arranged in gaps between the horizontal drum and the feed side sealing cover as well as between the horizontal drum and the discharge side sealing cover. Clearances between the feed side sealing cover and the horizontal drum as well as between the discharge side sealing cover and the horizontal drum are adjusted by adjusting the relative positions of the waist-shaped hole grooves of the feed side sealing cover and the discharge side sealing cover and the integrated base, so as to prevent material leakage from the gaps between the feed side sealing cover as well as the discharge side sealing cover and both ends of the inclined horizontal drum. The labyrinth sealing structure is simple, has no contact surface, and thus avoids wear problem, and is not affected by movement and vibration of the drum.

In the present disclosure, the solid high-temperature aerobic fermentation reactor is provided with the integrated base, and the supporting wheel sets, the stop wheel, the power driving device, the feed side sealing cover and the discharge side sealing cover are fixed to the integrated base to form a standard plane, so that the relative positions of all the components may be accurately positioned, and the clearance between components may be within a reasonable range. The horizontal drum of the solid high-temperature aerobic fermentation reactor is allowed to rotate successfully without being locked to guarantee efficient operation of the solid high-temperature aerobic fermentation reactor.

In the present disclosure, fresh air that enters the solid high-temperature aerobic fermentation reactor is heated by the odor heat exchange condenser, so as to avoid fluctuation of material temperature in the solid high-temperature aerobic fermentation reactor caused by oxygen supply and air exchange. In the high-temperature aerobic fermentation reaction process, the control system automatically controls the opening of the circulating water three-way electric regulation valve according to the temperatures of the materials in the solid high-temperature aerobic fermentation reactors, so that the temperatures of the fermentation materials are stabilized at a set temperature all the time and the materials in the solid high-temperature aerobic fermentation reactors are kept in an efficient fermentation state all the time.

The present disclosure fully considers the characteristics of high heat and high humidity of the organic waste fermentation odor, and creatively designs a heat exchange condenser. The hot odor included in the heat exchange condenser tube is convected with the fresh air outside the tube to fully exchange heat. Compared with the traditional heat exchange mode, the method is large in heat exchange specific surface area and high in heat exchange efficiency. Meanwhile, the fresh air is heated into hot air through the heat exchange condenser, and the hot air may serve as a hot source for the organic waste to heat and supply oxygen to the organic waste, thereby shortening the organic waste fermentation and heating time and increasing the fermentation efficiency.

Due to the high humidity of the organic waste fermentation odor, a large amount of condensed water is also generated while the odor is cooled by the heat exchange condenser, and the condensed water is naturally collected into the lower end cover of the heat exchange condenser through the heat exchange pipe. When the liquid level of the condensed water reaches a certain height, the condensed water is naturally discharged into the ditch due to the pressure difference. This mode is simple and feasible in operation, and the condensed water drainage port of the lower end cover is sealed by the condensed water to prevent the condensed odor from being discharged to the atmosphere through the condensed water drainage port of the lower end cover and causing secondary pollution.

The present disclosure utilizes the odor heat exchange condenser to absorb the heat in the fermentation odor to reduce the odor temperature, and also controls the temperature range of the odor that enters the biological deodorization filtering tower through the bypass branch to avoid microbial failure and reduction of the deodorization effect due to too high or too low odor that enters the biological deodorization filtering tower. The present disclosure not only ensures the deodorization effect, but also prevents the microorganisms in the biological deodorization filtering tower from sleeping and dying, and simultaneously uses the heat exchange condenser to absorb the heat in the fermentation odor or the hot water boiler flue gas to heat the fresh air. The heated air is conveyed into the solid high-temperature aerobic fermentation reactor or the hot water boiler to provide fresh hot air to the materials in the high-temperature aerobic fermentation reactors or boilers to increase the efficiency and reduce energy consumption.

The solid high-temperature aerobic fermentation reaction system and method involved in the present disclosure have small occupation area, no influence caused by the environmental factors and low-temperature conditions, high fermentation efficiency, no secondary pollution, no odor and heat emission, and good environmental protection effect, and can be applied to urban residential areas, large vegetable wholesaling markets, sewage treatment plants, villages and towns, intensive breeding farms and breeding areas for treating pollutant sources of feces, sludge and garbage.

### DESCRIPTION OF THE DRAWINGS

FIG. 1 is a schematic diagram of a solid high-temperature aerobic fermentation reaction system and method in the present disclosure;

FIG. 2 is a schematic diagram of an entire structure of a solid high-temperature aerobic fermentation reactor;

FIG. 3 is a schematic diagram of a specific structure of a solid high-temperature aerobic fermentation reactor;

FIG. 4 is a sectional view of an embodiment 1 of a sealing cover labyrinth sealing device;

FIG. 5 is an A enlarged view of FIG. 4;

FIG. 6 is a sectional view of an embodiment 2 of a sealing cover labyrinth sealing device;

FIG. 7 is a C enlarged view of FIG. 6;

FIG. 8 is a side view of a sealing cover labyrinth sealing device;

FIG. 9 is a schematic diagram of a side structure of a power supporting wheel set;

FIG. 10 is a schematic diagram of a section structure of a power supporting wheel set;

FIG. 11 is a schematic diagram of a parallel shoveling plate cage-shaped structure;

FIG. 12 is a schematic diagram of an inclined shoveling plate cage-shaped structure;

FIG. 13 is a schematic diagram of a boiler system;

FIG. 14 is a schematic diagram of an odor and flue gas treatment system; and

FIG. 15 is a structural schematic diagram of a stop wheel.

### LIST OF REFERENCE NUMERALS

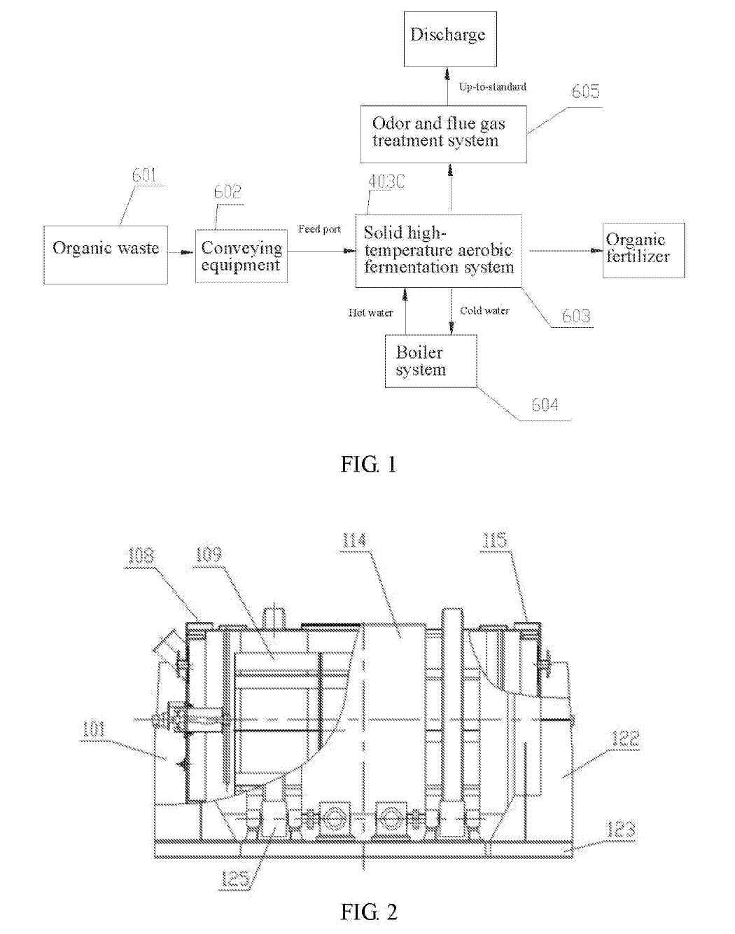

Numbering in FIG. 1: 601-organic waste; 602-organic waste conveying equipment; 603-solid high-temperature aerobic fermentation system; 604-boiler system; 605-odor and flue gas treatment system;

Numbering in FIG. 2: 101-feed side sealing cover; 108-feed side sealing device; 109-cage-shaped structure; 114-horizontal drum; 115-discharge side sealing device; 122-discharge side sealing cover; 123-integrated base; 200-power supporting wheel set;

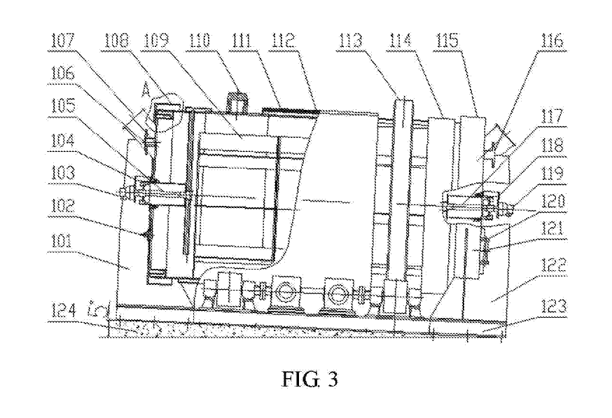

Numbering in FIG. 3: 101-feed side sealing cover; 102-material temperature sensor; 103-feed side water jacket rotating joint; 104-solid high-temperature aerobic fermentation reactor water outlet flange; 105-feed side water jacket extraction pipe; 106-solid high-temperature aerobic fermentation reactor exhaust hole; 107-solid high-temperature aerobic fermentation reactor feed hole; 108-feed side sealing device; 109-cage-shaped structure; 110-feed side rolling ring; 111-water jacket; 112-heat preservation layer; 113-discharge side rolling ring; 114-horizontal drum; 115-discharge side sealing device; 116-solid high-temperature aerobic fermentation reactor air inlet hole; 117-discharge side water jacket extraction pipe; 118-solid high-temperature aerobic fermentation reactor water inlet flange; 119-discharge side water jacket rotating joint; 120-discharge gate; 121-solid high-temperature aerobic fermentation reactor discharge hole; 122-discharge side sealing cover; 123-integrated base; 124-concrete foundation;

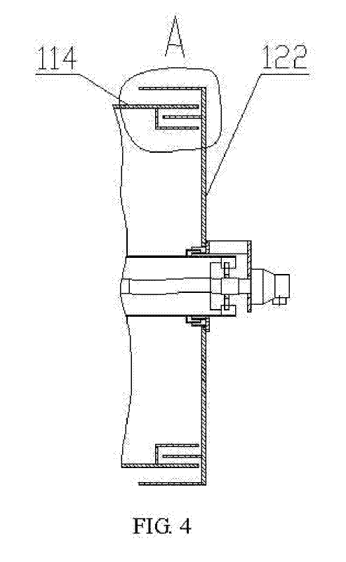

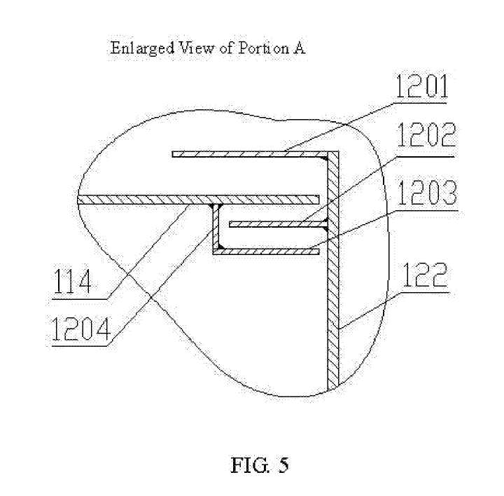

Numbering in FIG. 4 to FIG. 8: 114-horizontal drum; 122-sealing cover; 1201-sealing cover outer hood; 1202-sealing cover inner hood A; 1203-drum ring hood A; 1204-drum lining ring; 1205-sealing cover inner hood B; 1206-drum ring hood B;

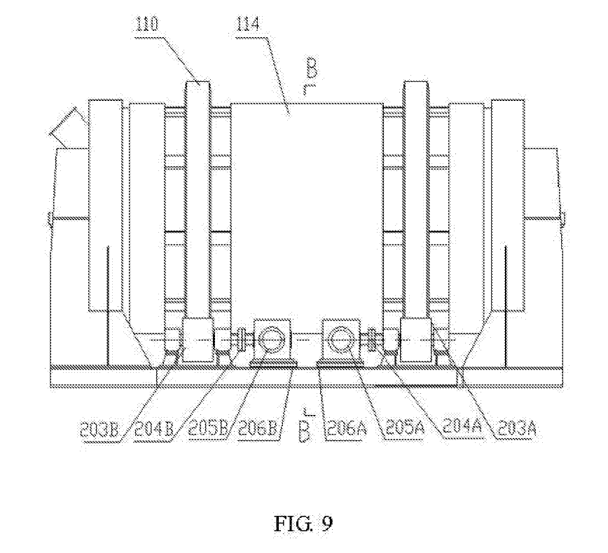

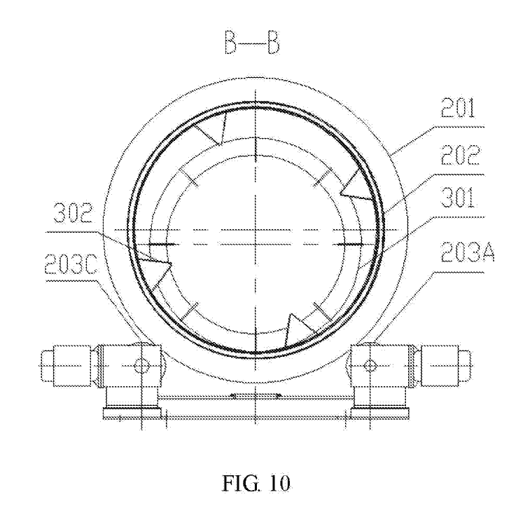

Numbering in FIG. 9 and FIG. 10: 201-rolling ring; 202-drum; 203A-supporting wheel; 203B-supporting wheel; 204A-shaft coupler; 204B-shaft coupler; 205A-motor; 205B-motor; 206A-speed reducer; 206B-speed reducer; 301-cage-shaped structure; 302-contact block; 203C-supporting wheel;

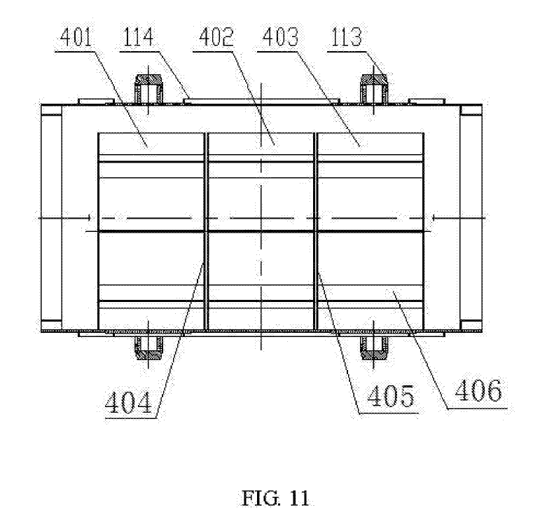

Numbering in FIG. 11: 401-parallel shoveling plate left side cage-shaped structure; 402-parallel shoveling plate middle side cage-shaped structure; 403-parallel shoveling plate right side cage-shaped structure; 404-parallel shoveling plate middle side cage-shaped structure left supporting plate; 405-parallel shoveling plate middle side cage-shaped structure right supporting plate; 406-parallel shoveling plate;

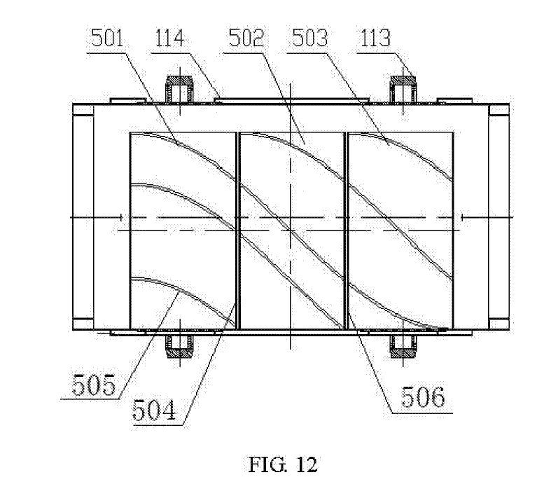

Numbering in FIG. 12: 501-inclined shoveling plate left side cage-shaped structure; 502-inclined shoveling plate middle side cage-shaped structure; 503-inclined shoveling plate right side cage-shaped structure; 504-inclined shoveling plate middle side cage-shaped structure left supporting plate; 505-inclined shoveling plate; 506-inclined shoveling plate middle side cage-shaped structure right supporting plate;

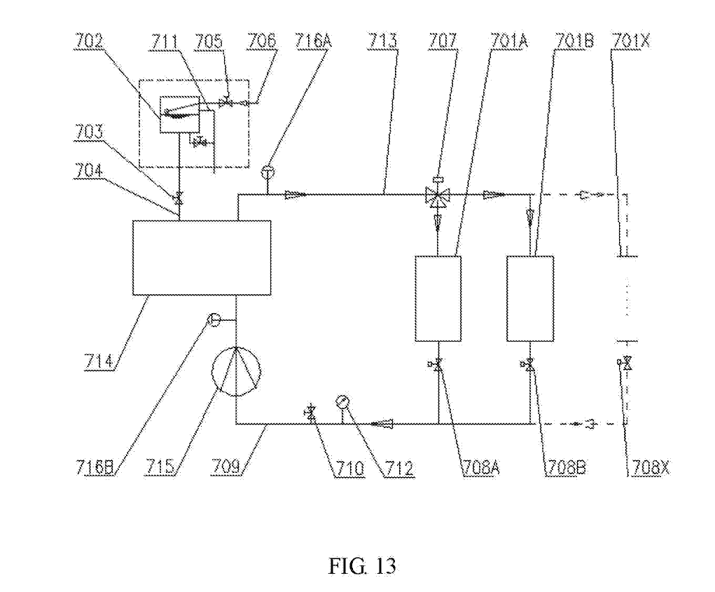

Numbering in FIG. 13: 701A-solid high-temperature aerobic fermentation reactor; 701B-solid high-temperature aerobic fermentation reactor: 701X-solid high-temperature aerobic fermentation reactor; 702-pressure water tank; 703-hot water boiler water inlet valve; 704-water inlet pipeline of hot water boiler; 705-water supplementing valve; 706-water supplementing pipe; 707-three-way electric regulation valve; 708A-electromagnetic valve; 708B-electromagnetic valve; 701X-electromagnetic valve; 709-hot water boiler water return pipeline; 710-exhaust valve; 711-overflow pipe; 712-pressure gauge; 713-hot water boiler water outlet pipeline; 714-hot water boiler; 715-circulating water pump; 716A-boiler water outlet temperature sensor; 716B-boiler water return temperature sensor;

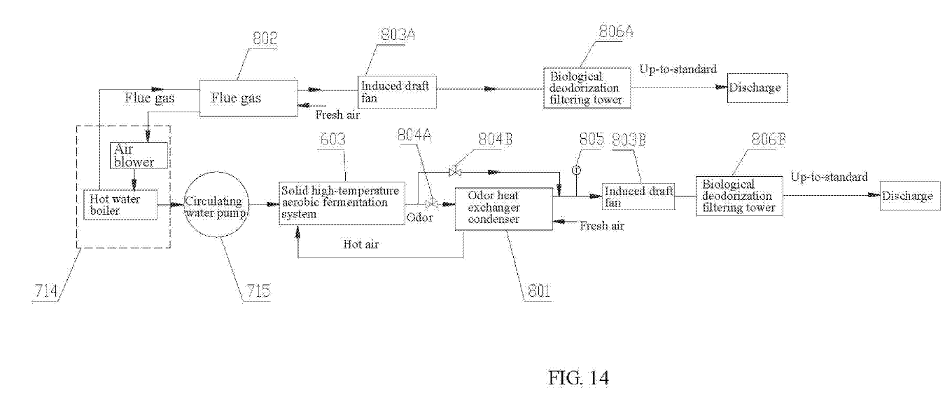

Numbering in FIG. 14: 801-odor heat exchange condenser; 802-flue gas heat exchange condenser; 803A-induced draft fan A; 803B-induced draft fan B; 804A-electromagnetic valve; 804B-electromagnetic valve; 805-temperature sensor; 806A-biological deodorization filtering tower A; 806B-biological deodorization filtering tower B;

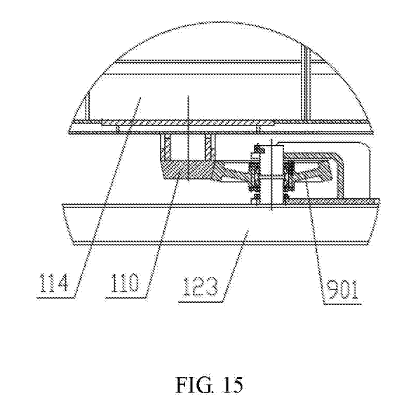

Numbering in FIG. 15: 901-stop wheel.

### DETAILED DESCRIPTION OF PREFERRED EMBODIMENTS

The structural schematic diagram of the solid high-temperature aerobic fermentation reactor is shown in FIG. 2 and FIG. 3. The solid high-temperature aerobic fermentation reactor is composed of an inclined horizontal drum 114, a feed side sealing cover 101, a labyrinth sealing device 108, a discharge side sealing cover 122, a labyrinth sealing device 115, a power supporting wheel set 200, a stirring and anti-sticking device 109 and an integrated base 123. The feed side is higher than the discharge side. The horizontal drum 114, the feed side sealing cover 101, the discharge side sealing cover 122 and the labyrinth sealing devices (108 and 115) on both sides form a closed fermentation space. A feed hole 107 and an exhaust hole 106 are formed in the upper part of the feed side sealing cover 101. An air inlet hole 116 is formed in the upper part of the discharge side sealing cover 122. A discharge hole 121 is formed in the lower part of the discharge side sealing cover 122. A discharge gate 120 is installed on the discharge hole.

A water jacket 111 is welded outside the horizontal drum 114, and is divided into a plurality of parts by a feed side rolling ring 110 and a discharge side rolling ring 113 on the horizontal drum 114. The water jacket 111 is connected into a whole through a water jacket connection pipe. The water jacket 111 is connected with a solid high-temperature aerobic fermentation reactor water inlet flange 118 by a feed side water jacket extraction pipe 105 through a feed side water jacket rotating joint 103 arranged in the center of the feed side sealing cover 101. The water jacket 111 is connected with a solid high-temperature aerobic fermentation reactor water outlet flange 104 by a discharge side water jacket extraction pipe 117 through a discharge side water jacket rotating joint 119 arranged in the center of the discharge side sealing cover 122. The water inlet flange 118 and the water outlet flange 104 of the solid high-temperature aerobic fermentation reactor are connected with the boiler system to form a circulating loop. A heat preservation layer 112 is arranged outside the water jacket 111, so that radiation waste of heat energy may be reduced.

The stirring and anti-sticking device 109 is positioned in the horizontal drum 114. The horizontal drum 114 is arranged on the power supporting wheel set 200. The power supporting wheel set 200, the feed side sealing cover 101 and the discharge side sealing cover 122 are fixed to the inclined integrated base 123 to form a whole. The integrated base 123 is fixed to an inclined concrete foundation 124 through second pouring; the basic plane of the concrete foundation 124 and the gradient of a horizontal plane form an adjustable included angle of 0-5 degrees. The conveying speed of fermentation raw materials to the discharge end may be adjusted by adjusting the included angle.

The structural schematic diagram of the labyrinth sealing device involved, in the present disclosure is shown in FIG. 4 to FIG. 8. The structure of the sealing device is sealed in a labyrinth manner. Sealing between the drum 114 and the feed side sealing cover 101 and sealing between the drum 114 and the discharge side sealing cover 122 are labyrinth sealing. The labyrinth sealing is implemented on the inner sides of the two sealing covers (the feed side sealing cover 101 and the discharge side sealing cover 122). As shown in FIG. 4, an outer hood 1201 and an inner hood 1202 which are coaxial with each other are perpendicularly welded on the inner side of the discharge side sealing cover 122. Correspondingly, coaxial lining rings 1204 are welded in parts, positioned on both sides, of the drum 114. The perpendicular lining rings 1204 are welded with coaxial ring hoods 1203 having an outer diameter less than the inner diameter of the drum 114. The inner diameter of the sealing cover outer hood 1201 is greater than the outer diameter of the drum 114. The inner diameter of the sealing cover inner hood 1202 is greater than the outer diameter of the ring hood 1203. The outer diameter of the sealing cover inner hood 1202 is less than the inner diameter of the drum 114. The depth of the sealing cover inner hood 1202 is equal to that of the ring hood 1203. The labyrinth sealing effect is guaranteed by gaps between the inner sides of the sealing covers (the feed side sealing cover 101 and the discharge side sealing cover 122) and the end surfaces of the drum 114. If the gaps between the inner sides of the sealing covers (the feed side sealing cover 101 and the discharge side sealing cover 122) and the end surfaces of the drum 114 are smaller, fewer materials are leaked, so that the positions of the end covers (the feed side sealing cover 101 and the discharge side sealing cover 122) on both sides are adjusted to allow the drum 114 to rotate flexibly, so as to achieve a sealing effect of least leakage.

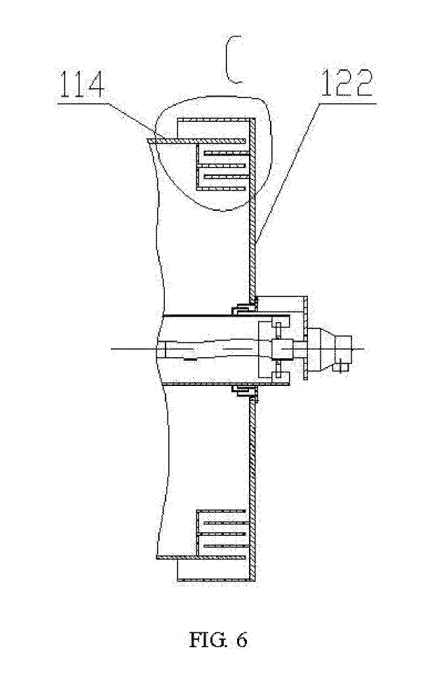

Further, the number of labyrinths is increased to lengthen the labyrinths and reduce the leakage. As shown in FIG. 6, an outer hood 1201, an, inner hood A1202 and an inner hood B1205 which are coaxial are perpendicularly welded on the inner side of the discharge side sealing cover 122. Correspondingly, coaxial lining rings 1204 are welded in parts, positioned on both sides, of the drum 114. The perpendicular lining rings 1204 are welded with a ring hood A1203 and a ring hood B1206 coaxial with each other and having an outer diameter less than the inner diameter of the drum 114. The inner diameter of the sealing cover outer hood 1201 is greater than the outer diameter of the drum 114. The inner diameter of the sealing cover inner hood A1202 is greater than the outer diameter of the ring hood A1203, The outer diameter of the sealing cover inner hood A1202 is less than the inner diameter of the drum 114. The inner diameter of the sealing cover inner hood B1205 is greater than the outer diameter of the ring hood B1203. The inner diameter of the ring hood A1202 is greater than the outer diameter of the sealing cover inner hood B1205. The depth of the sealing cover inner hood A1202 is equal to those of the sealing cover inner hood B1205, the ring cover A1203 and the ring cover B1206, that is, the four hoods have the consistent depths. The labyrinth sealing effect is guaranteed by gaps between the inner sides of the sealing covers (the feed side sealing cover 101 and the discharge side sealing cover 122) and the end surfaces of the drum 114. If the gaps between the inner sides of the sealing covers (the feed side sealing cover 101 and the discharge side sealing cover 122) and the end surfaces of the drum 114 are smaller, fewer materials are leaked, so that the positions of the end covers (the feed side sealing cover 101 and the discharge side sealing cover 122) on both sides are adjusted to allow the drum 114 to rotate flexibly, so as to achieve a sealing effect of least leakage.

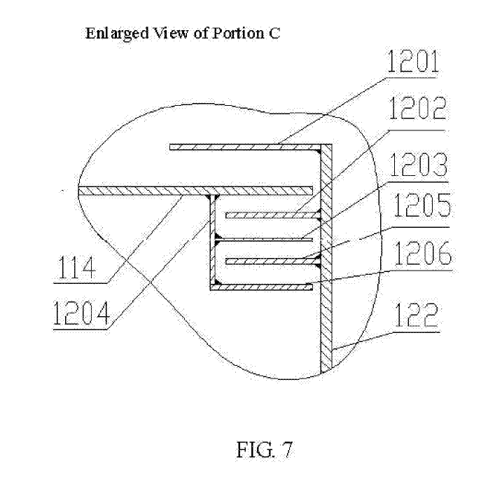

The structural schematic diagram of the side surface and the structural schematic diagram of the cross section of the power supporting wheel set 200 are shown in FIG. 6 and FIG. 7. The power supporting wheel set 200 is composed of two groups of supporting wheels and power driving devices thereof and the like. Power driving adopts four-wheel driving. In FIG. 3 of the structural schematic diagram of the side surface, the structure of the first power driving device is that: a motor 205A, a speed reducer 206A and a shaft coupler 204A are connected with the supporting wheel 203A in sequence and are in connection transmission in sequence. The structure of the second power driving device is that: a motor 205B, a speed reducer 206B and a shaft coupler 204B are connected with the supporting wheel 203B in sequence and are in connection transmission in sequence. In this way, each supporting wheel is a driving wheel. The two groups of supporting wheels are in linear contact with the rolling ring 201 of the horizontal drum 114. The power supporting wheel set is controlled to coordinately drive the horizontal drum 114 to rotate.

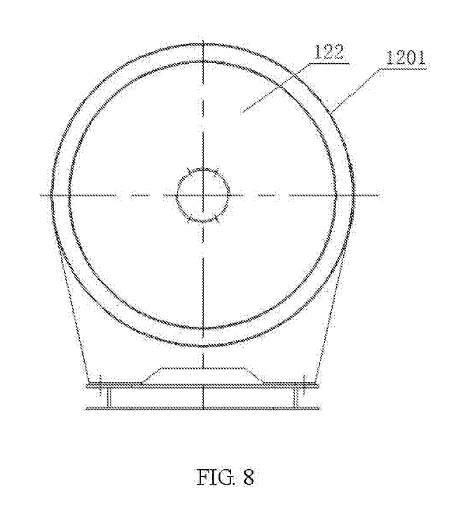

The stirring and anti-sticking system is composed of one or more cage-shaped structures 109. According to a state whether the axes of the cage-shaped structures 109 are parallel to the shoveling plates, the cage-shaped structures are divided into parallel shoveling plate cage-shaped structures and inclined shoveling plate cage-shaped structures. The schematic diagram of the parallel shoveling plate cage-shaped structure is shown in FIG. 8. The stirring and anti-sticking system is composed of the parallel shoveling plate left side cage-shaped structure 401, the parallel shoveling plate middle side cage-shaped structure 402 and the parallel shoveling plate right side cage-shaped structure 403. Each cage-shaped structure is composed of a left supporting plate, a right supporting plate and a plurality of shoveling plates. The left and the right supporting plates are circular rings and are coaxial. The plurality of shoveling plates are arranged between the supporting plates. As shown in FIG. 8, the parallel shoveling plate middle side cage-shaped structure 402 is composed of a parallel shoveling plate middle side cage-shaped structure left supporting plate 404, a parallel shoveling plate middle side cage-shaped structure right supporting plate 405 and a plurality of shoveling plates 406. The left supporting plate 404 and the right supporting plate 405 are coaxial, and a plurality of parallel shoveling plates 406 are arranged between the left supporting plate 404 and the right supporting plate 405. The shoveling plates 406 are parallel to the axis of the horizontal drum 114. The structural schematic diagram of a contact block is shown in FIG. 3. A general shovel plate structure is not disposed on the inner wall of the horizontal drum 114. On the inner wall, a plurality of contact blocks 302 are uniformly fixed relative to gap positions of cage-shaped structures 109 of the stirring and anti-sticking device.

When the horizontal drum 114 rotates, the contact blocks 302 on the inner wall drive a parallel shoveling plate left side cage-shaped structure 401, a parallel shoveling plate middle side cage-shaped structure 402 and a parallel shoveling plate right side cage-shaped structure 403 to rotate at the same time. Because shoveling plates 406 of the cage-shaped structures have certain widths, the three cage-shaped structures 401, 402 and 403 drive materials at the bottom of the horizontal drum 202 to move upwards. Under the gravity action, the materials are separated from the shoveling plates and thrown away, and fall to the bottom of the horizontal drum 202, so as to achieve material throwing and stirring effects. Because the outer diameters of the parallel shoveling plate left side cage-shaped structure 401, the parallel shoveling plate middle side cage-shaped structure 402 and the parallel shoveling plate right side cage-shaped structure 403 are less than the inner diameter of the horizontal drum 202, gaps are also reserved between the contact blocks 302 and the three cage-shaped structures 401, 402 and 403. When the horizontal drum 202 rotates, the three cage-shaped structures 401, 402 and 403 and the horizontal drum 202 generate relative movement. By virtue of collision and scratching between left supporting plates and right supporting plates of the three cage-shaped structures 401, 402 and 403 as well as between the shoveling plates and the inner wall of the horizontal drum 202, the materials possibly adhered on the inner surface of a drum body of the horizontal drum 202 may be cleaned, so as to achieve an effect of preventing the materials in the horizontal drum 202 from being adhered to the inner wall of the horizontal drum 202.

The schematic diagram of the inclined shoveling plate cage-shaped structure is shown in FIG. 9. The stirring and anti-sticking system is composed of an inclined shoveling plate left side cage-shaped structure 501, an inclined shoveling plate middle side cage-shaped structure 502 and an inclined shoveling plate right side cage-shaped structure 503. Each cage-shaped structure is composed of a left supporting plate, a right supporting plate and a plurality of inclined shoveling plates. The left and the right supporting plates are circular rings and are coaxial. The plurality of inclined shoveling plates are disposed between the supporting plates. The inclined shoveling plates are inclined to their axes at certain angles. The inclined shoveling plate middle side cage-shaped structure 502 is composed of a left supporting plate 504, a right supporting plate 505 and a plurality of inclined shoveling plates 506. When the horizontal drum 202 rotates, the contact blocks 302 on the inner wall drive the inclined shoveling plate left side cage-shaped structure 501, the inclined shoveling plate middle side cage-shaped structure 502 and the inclined shoveling plate right side cage-shaped structure 503 to rotate at the same time. Because the shoveling plates 506 of the cage-shaped structures have certain widths, the three cage-shaped structures 501, 502 and 503 drive materials at the bottom of the horizontal drum 202 to move upwards. Under the gravity action, the materials are separated from the shoveling plates and thrown away, and fall to the bottom of the horizontal drum 202. When the materials are thrown away, because the shoveling plates of the three cage-shaped structures (501, 502 and 503) form certain angles to their axes, a forward thrust is generated while the materials are thrown away to allow the materials to move from the feed side to the discharge side so as to achieve material throwing, stirring and guiding effects.

The structural schematic diagram of a stop wheel is shown in FIG. 12. The stop wheel 901 is connected to the integrated base 123 in a bolting manner. A waist-shaped hole groove is formed in a stop wheel seat. The stop wheel 901 is adjusted through the waist-shaped hole groove so that the stop wheel 901 comes into contact with the side line of the discharge side rolling ring 113. The stop wheel 901 keeps off an axial component force of the horizontal drum 114, so as to prevent the horizontal drum 114 from moving along the axis.

The schematic diagram of a solid high-temperature aerobic fermentation reaction system and method is shown in FIG. 1. The system is mainly composed of a solid high-temperature aerobic fermentation system 603, a boiler system 604, an odor and flue gas treatment system 605, a detection system and a control system. Organic waste 601 is conveyed into a solid high-temperature aerobic fermentation reactor through conveying equipment 602 via the feed hole of the solid high-temperature aerobic fermentation system 603. The boiler system 604 is connected with the water jacket of the solid high-temperature aerobic fermentation system 603 through the pipeline, so as to provide heat for the solid high-temperature aerobic fermentation system 603. Odor exhausted by the solid high-temperature aerobic fermentation system 603 and flue gas exhausted by the boiler system 604 are treated by the odor and flue gas treatment system 605, and discharged to the atmosphere after reaching the standard.

The schematic diagram of a boiler system is shown in FIG. 10. The solid high-temperature aerobic fermentation system 603 is composed of 1 to X solid high-temperature aerobic fermentation reactors 701A, 701B . . . 701X, wherein X is more than or equal to 1. The boiler system 604 includes a hot water boiler 714, a circulating water pump 715, a pressure water tank 702, a three-way electric regulation valve 707, an electromagnetic valve 708, a temperature sensor 716 and the like. A water inlet pipeline 704 of the hot water boiler 714 is connected with the water outlet of the pressure water tank 702. A water inlet valve 703 is disposed on the water inlet pipeline 704. The water inlet of the pressure water tank 702 is connected with a water supplementing pipe 706. The water supplementing pipe 706 is provided with a water supplementing valve 705. A water outlet pipeline 713 of the hot water boiler 714 is connected to the input end of the three-way electric regulation valve 707. Two output ends of the three-way electric regulation valve 707 are respectively connected with the water inlet flanges of a plurality of solid high-temperature aerobic fermentation reactors 701A, 701B . . . 701X in parallel, and X is more than or equal to 1. The water outlet flanges of the solid high-temperature aerobic fermentation reactors 701A, 701B . . . 701X are connected with the water return pipeline 709 of the hot water boiler 714. The water outlet pipelines of the solid high-temperature aerobic fermentation reactors 701A, 701B . . . 701X are respectively provided with electromagnetic valves 708A, 708B . . . 708X. The water outlet pipeline 713 and the water return pipeline 709 of the hot water boiler 714 are respectively provided with a boiler water outlet temperature sensor 716A and a boiler water return temperature sensor 716B. The water return pipeline 709 is also provided with a circulating water pump 715, an exhaust valve 710 and a pressure gauge 712.

The schematic diagram of an odor and flue gas system involved in the present disclosure is shown in FIG. 11. The odor and flue gas treatment system mainly includes an odor heat exchange condenser 801, a flue gas heat exchange condenser 802, an induced draft fan 803A, an induced draft fan 803B, an electromagnetic valve 804A, an electromagnetic valve 804B, a temperature sensor 805, a biological deodorization filtering tower 806A, a biological deodorization filtering tower 806B, etc. An exhaust hole 106 of solid high-temperature aerobic fermentation reactors 701A, 701B . . . 701X is connected with the heat exchange input end of the odor heat exchange condenser 801 through the pipeline. The heat exchange output end of the odor heat exchange condenser 801 is connected with the input end of the induced draft fan 803B through the pipeline. The output end of the induced draft fan 803B is connected with the air inlet of the biological deodorization filtering tower 806B through the pipeline. The air input end of the induced draft fan 803B is communicated with the atmosphere, and the air output end is connected to the air inlet hole 116 of each of the solid high-temperature aerobic fermentation reactors 701A, 701B . . . 701X through the pipeline. The temperature sensor 805 is installed on the heat exchange output pipeline of the odor heat exchange condenser 801. The smoke vent of the hot water boiler 714 is connected with the heat exchange input end of the flue gas heat exchange condenser 802 through the pipeline. The heat exchange output end of the flue gas heat exchange condenser 802 is connected with the input end of the induced draft fan 803A through the pipeline. The output end of the induced draft fan 803A is connected with the air inlet of the biological deodorization filtering tower 806A through the pipeline. The air input end of the flue gas heat exchange condenser 802 is communicated with the atmosphere, and the air output end is connected to the air inlet of the air blower of the hot water boiler 714 through the pipeline.

An aerobic fermentation reaction method based on the solid high-temperature aerobic fermentation reaction system in the present disclosure is specifically implemented as follows:

(1) The boiler system 604 is started; the hot water boiler 714 heats the circulating water; the circulating hot water enters an external water jacket 111 of the solid high-temperature aerobic fermentation reactors 701A, 701B . . . and 701X, so that the solid high-temperature aerobic fermentation reactors 701A, 701B . . . and 701X are heated and the circulating water is heated to a set temperature suitable for high-temperature aerobic fermentation.

(2) External conveying equipment 602 is started; fermentation raw materials and accessories, and a high-temperature aerobic bacteria are fed into the solid high-temperature aerobic fermentation reactors 701A, 701B . . . and 701X through the conveying equipment 602.

(3) During feeding, the control system starts all power driving devices at the same time to allow all power supporting wheel sets 123 to rotate at the same time to drive a horizontal drum 202 of the solid high-temperature aerobic fermentation reactors 701A, 701B . . . and 701X to rotate forwards; by virtue of the action of the stirring and anti-sticking device 301 in the solid high-temperature aerobic fermentation reactors 701A, 701B . . . and 701X, fermentation raw materials are conveyed to the discharge side, and organic waste is shoveled up and dropped down so that the organic waste is fully stirred and mixed with oxygen, thereby enlarging the contact area of the fermentation raw materials and the oxygen.

(4) The boiler system 604 and the odor and flue gas treatment system 605 are started at the same time; odor exhausted, by the solid high-temperature aerobic fermentation reactors 701A, 701B . . . and 701X is cooled by the odor heat exchange condenser 801, then is conveyed to the biological deodorization filtering tower 806B for absorption and conversion and is discharged into the atmosphere through the exhaust port of the biological deodorization filtering tower 806B after reaching the standard; flue gas exhausted by the hot water boiler 714 exchanges heat through the flue gas heat exchange condenser 802, is led to the biological deodorization filtering tower 806A through the induced draft fan 803A, then is absorbed and converted through the biological deodorization filtering tower 806A and is discharged into the atmosphere through the exhaust port of the biological deodorization filtering tower 806A after reaching the standard; meanwhile, fresh air heated by the flue gas heat exchange condenser 802 is blasted into hot water boiler 714 through an air blower of the hot water boiler 714 to provide fresh hot air for the hot water boiler 714; condensed water produced by heat exchange between hot odor, and flue gas and cold air in the odor heat exchange condenser 801 and the flue gas heat exchange condenser 802 is drained into a natural ditch through the odor heat exchange condenser 801 and the flue gas heat exchange condenser 802 via pipelines.

(5) When the amount of organic waste raw materials which are conveyed into the solid high-temperature aerobic fermentation reactors 701A, 701B . . . and 701X achieves the requirement, the control system controls to stop feeding.

(6) In the high-temperature aerobic fermentation reaction process, the control system automatically controls the opening of the circulating water three-way electric regulation valve 707 according to the temperatures of the materials in the solid high-temperature aerobic fermentation reactors 701A, 701B . . . and 701X, so that the temperatures of the fermentation materials are stabilized at a set temperature all the time; when the temperature of the material in the solid high-temperature aerobic fermentation reactor 701A of the first fermentation object is less than the set value, the opening of the three-way electric regulation valve 707 in this loop is 100%, and the openings in the loops of other solid high-temperature aerobic fermentation reactors are 0; when the temperature of the material in the solid high-temperature aerobic fermentation reactor 701A of the first fermentation object is close to the set value, the control system controls to turn on the electromagnetic valve in the loop of the solid high-temperature aerobic fermentation reactor 701B of the second fermentation object, and the three-way electric regulation valve 707 performs PID regulation to allow part of the hot circulating water to flow through the water jacket 11 of the second solid high-temperature aerobic fermentation reactor 701B, so that the second solid high-temperature aerobic fermentation reactor 701B is heated under the condition of stabilizing the temperature of the material in the first solid high-temperature aerobic fermentation reactor 701A at the set value; because the aerobic fermentation process is a heat release process, along with the fermentation, the temperatures of the materials in the solid high-temperature aerobic fermentation reactors 701A, 701B . . . and 701X continuously rise up; when the temperature of the material in the first fermentation object 701A is greater than the set value, the control system slows down or shuts off the heating of the hot water boiler 714; under the action of the circulating pump 715, the circulating water of the first fermentation object 701A is mixed with the circulating water of the second fermentation object 701B, resulting in that the temperature of the material in the first fermentation object 701A is reduced, and the temperature of the material in the second fermentation object 701B is increased; the three-way electric regulation valve 707 and the electromagnetic valves 708A, 708B . . . and 708X are coordinately controlled by the control system to convey fermentation reaction heat of the first fermentation reactor 701A and heat generated by heating of the hot water boiler 714 to the second solid high-temperature aerobic fermentation reactor 701B or the Xth solid high-temperature aerobic fermentation reactor 701X, so that the temperatures of the materials in the solid high-temperature aerobic fermentation reactors 701A, 701B . . . and 701X may be stabilized at the set value, and the heat energy generated by the fermentation reaction may be recycled.

(7) In an aerobic fermentation reaction process, the control system controls the power supporting wheel set devices of the solid high-temperature aerobic fermentation reactors 701A, 701B . . . and 701X to operate in a periodic intermittent operation manner of backward rotation-stop-backward rotation-stop . . . according to a detected temperature of the fermentation raw material; for the shoveling plate 406 or 506 of the cage-shaped structure 301, during forward rotation of the horizontal drum 114, the supporting wheel sets drive the materials at the bottom of the horizontal drum 114 to move upwards, and the materials are separated from the shoveling plate (406 or 506) under the action of the gravity of the materials and are thrown away and dropped back to the bottom of the horizontal drum 114, so as to achieve the stirring effect; by virtue of the action of the spiral shoveling plates (406 or 506) in the solid high-temperature aerobic fermentation reactors 701A, 701B . . . and 701X, the backward rotating drum 114 shovels up the materials and conveys the fermentation raw materials to the feed side, so that the fermentation materials may not be compacted on the discharge side sealing cover 122; meanwhile, the fermentation raw materials adhered to the inner wall of the solid high-temperature aerobic fermentation reactors 701A, 701B . . . and 701X are reduced, and the energy consumption caused by stirring, is minimized.

(8) When detecting that the odor temperature detected by the temperature sensor 805 installed on the main-path air inlet pipeline of the biological deodorization filtering tower 806B is more than 40° C., the control system turns on the electromagnetic valve 804A on the air inlet pipeline of the odor heat exchange condenser 801 and turns off the electromagnetic valves 804B of the bypass branches to allow the odor entering the biological deodorization filtering tower 806B to be cooled by the odor heat exchange condenser 801; when detecting that the odor temperature detected by the temperature sensor 805 installed on the main-path air inlet pipeline of the biological deodorization filtering tower 806B is less than 15° C., the control system turns off the electromagnetic valves 804A on the air inlet pipeline of the odor heat exchange condenser 801 and turns on the electromagnetic valves 804B of the bypass branches to forbid the odor to enter the odor heat exchange condenser 801 for cooling; therefore, the biological deodorization filtering tower 806B works in a temperature range between 15° C. and 40° C., so as to guarantee the deodorization effect and prevent dormancy or death of microorganisms in the biological deodorization filtering tower 806B.

(9) When one solid high-temperature aerobic fermentation reactor 701A, 701B . . . or 701X completes the high-temperature aerobic fermentation reaction, the control system controls to turn off the electromagnetic valve 708A, 708B . . . or 708X at the front ends of the power driving device and a water inlet pipeline of the water jacket of the solid high-temperature aerobic fermentation reactor 701A, 701B . . . or 701X, and controls to turn on a discharge gate 120 at the same time; then the control system controls the power driving device to continuously rotate forwards to discharge part of old fermentation materials to the next working procedure for treatment through external conveying equipment.

(10) The above steps are repeated so that the biological fermentative degradation reaction of the organic waste is circulated at high speed.

We claim:

1. A solid high-temperature aerobic fermentation reaction system, comprising a solid high-temperature aerobic fermentation system, a boiler system, an odor and flue gas treatment system and a test and control system, wherein the solid high-temperature aerobic fermentation system comprises 1 to X solid high-temperature aerobic fermentation reactors; X is more than or equal to 1; each solid high-temperature aerobic fermentation reactor comprises an inclined horizontal drum, a feed side sealing cover labyrinth sealing device, a discharge side sealing cover labyrinth sealing device, a power supporting wheel set, a stirring and anti-sticking device and an integrated base; a water jacket is arranged outside the horizontal drum; a feed side is higher than a discharge side; the horizontal drum, the feed side sealing cover labyrinth sealing device and the discharge side sealing cover labyrinth sealing device form a closed fermentation space: a feed hole and an exhaust hole are formed in an upper part of a feed side sealing cover; an air inlet hole is formed in an upper part of a discharge side sealing cover; a discharge hole is formed in the lower part of the discharge side sealing cover; a discharge gate is installed on the discharge hole; the stirring and anti-sticking device is positioned in the horizontal drum which is disposed on the power supporting wheel set; the power supporting wheel set, the feed side sealing cover and the discharge side sealing cover are fixed to the integrated base; the boiler system comprises a hot water boiler, a circulating water pump, a three-way electric regulation valve and an electromagnetic valve; the boiler system is connected with a jacket of the solid high-temperature aerobic fermentation reactor; the odor and flue gas treatment system comprises an odor heat exchange condenser, a flue gas heat exchange condenser, a biological deodorization filtering tower, an induced draft fan and an electromagnetic valve; an exhaust hole of the solid high-temperature aerobic fermentation reactor and a smoke vent of the hot water boiler are connected with the odor and flue gas treatment system; the test and control system is as follows: temperature sensors are installed on a water outlet pipeline and a water return pipeline of the hot water boiler; a material temperature sensor is disposed in the solid high-temperature aerobic fermentation reactor; material level sensors for confirming material positions are disposed on loading and unloading conveying equipment, a feed port and a discharge port; detection signals of the above sensors are input into an input end of a controller; and an output end of the controller controls the boiler system, the odor and flue gas treatment system, the solid high-temperature aerobic fermentation reactor and the external loading and unloading conveying equipment.

2. The solid high-temperature aerobic fermentation reaction system according to claim 1, wherein the water jacket outside the horizontal drum is divided into a plurality of parts by a rolling ring; the a plurality of parts are connected into a whole through a water jacket connection pipe; the water jacket is led to an axis of a horizontal drum sealing cover through a water jacket extraction pipe and is connected with an external circulating water pipe through a rotating joint installed at the axis of the sealing cover; and a heat preservation layer covers an outer surface of the water jacket arranged outside the horizontal drum and is made of heat preservation and isolation material.

3. The solid high-temperature aerobic fermentation reaction system according to claim 1, wherein at least four or more power supporting wheel sets are disposed, and every two power supporting wheel sets are symmetrically distributed on both sides of a bottom of the horizontal drum; a quantity of the power supporting wheel sets is determined according to a length of the horizontal drum; each of the power supporting wheel sets comprises a supporting wheel, a power driving device and a base; the power driving device structurally comprises a motor, a speed reducer and a shaft coupler which are connected successively, alternatively a motor, a speed reducer, a chain transmission device or a belt transmission device which are connected successively; the power driving device and supporting wheels are in transmission connection; and each of the supporting wheels is a driving wheel that drives the horizontal drum to rotate, so as to control the supporting wheels to coordinate and drive the horizontal drum to rotate.

4. The solid high-temperature aerobic fermentation reaction system according to claim 1, wherein a structure and principle of the feed side sealing cover labyrinth sealing device are completely the same as those of the discharge side sealing cover labyrinth sealing device, and each of the structures is that a lining ring having a radial plane consistent with the horizontal drum is fixed to an inner wall of the drum at a certain distance from an end of the horizontal drum; an outer circumference of the lining ring and the inner wall of the horizontal drum are consistent and are fixedly connected; a lining ring hood axially identical with the horizontal drum is fixedly installed on an inner circumference of the lining ring; correspondingly, two concentric sealing cover hoods are vertically welded on an inner side plane of the sealing cover: a sealing cover outer hood and a sealing cover inner hood; the sealing cover inner hood is positioned on an inner side of the sealing cover outer hood, the sealing cover outer hood is sleeved on an outer side of the end of the horizontal drum, and the sealing cover inner hood is sleeved between the inner wall of the horizontal drum and the lining ring hood; meanwhile, the following three heights are required to be consistent: a height of the lining ring hood, a height of the sealing cover inner hood and a distance from the lining ring to the end of the horizontal drum; and waist-shaped hole grooves are disposed in a feed side sealing cover and a discharge side sealing cover.

5. The solid high-temperature aerobic fermentation reaction system according to claim 1, wherein according to a length of the horizontal drum, the stirring and anti-sticking device is composed of one or more cage-shaped structures; when the horizontal drum is relatively short, the stirring and anti-sticking device may be composed of only one cage-shaped structure; when the horizontal drum is relatively long, the stirring and anti-sticking device is composed of a plurality of cage-shaped structures; each of the cage-shaped structures is composed of two coaxial supporting plates and a plurality of shoveling plates; the supporting plates are circular rings, and both ends of each of the shoveling plates are respectively connected and fixed with the two coaxial supporting plates; and correspondingly, contact blocks are disposed on an inner wall of the horizontal drum.

6. The solid high-temperature aerobic fermentation reaction system according to claim 1, wherein an axis of the cage-shaped structure is at a side of an axis of the horizontal drum, and does not coincide with the axis of the horizontal drum; namely, the cage-shaped structure is installed in a mode of deviating from the axis in the horizontal drum; a plurality of shoveling plates are parallel to the axis of the cage-shaped structure, or a plurality of shoveling plates form inclined angles with the axis of the cage-shaped structure, or a plurality of shoveling plates are curve shapes.

7. The solid high-temperature aerobic fermentation reaction system according to claim 1, wherein the water outlet pipeline of the hot water boiler is connected to an input end of the three-way electric regulation valve; two output ends of the three-way electric regulation valve are respectively connected with an in-parallel solid high-temperature aerobic fermentation reactor water inlet flange through the water outlet pipeline; an electromagnetic valve is connected to a water outlet pipeline of each solid high-temperature aerobic fermentation reactor; a water outlet end of the electromagnetic valve is connected with the water return pipeline of the hot water boiler; and the water return pipeline is provided with a circulating water pump to enable circulating water to form a loop.

8. The solid high-temperature aerobic fermentation reaction system according to claim 1, wherein the exhaust hole of the solid high-temperature aerobic fermentation reactor is connected with a heat exchange air inlet of the odor heat exchange condenser through a pipeline; a heat exchange air outlet of the odor heat exchange condenser is connected with an input end of the induced draft fan through a pipeline, and an output end of the induced draft fan is connected with an air inlet of the biological deodorization filtering tower through an air inlet pipeline; a temperature sensor is installed on a main-path air inlet pipeline of the biological deodorization filtering tower; odor exhausted by the solid high-temperature aerobic fermentation reactor passes through the odor heat exchange condenser, and then is connected with the biological deodorization filtering tower; the air inlet of the odor heat exchange condenser is connected with atmosphere, and an air outlet is connected with an air inlet hole of the solid high-temperature aerobic fermentation reactor; the smoke vent of the hot water boiler is connected with a heat exchange air inlet of the flue gas heat exchange condenser through a pipeline; a heat exchange air outlet of the flue gas heat exchange condenser is connected with the input end of the induced draft fan, and the output end of the induced draft fan is connected with the air inlet of the biological deodorization filtering tower; flue gas exhausted by the hot water boiler passes through the flue gas heat exchange condenser, and then is connected with the biological deodorization filtering tower; the air inlet of the flue gas heat exchange condenser is connected with atmosphere, and an air outlet is connected with an air inlet of an air blower of the hot water boiler; an air inlet pipeline of the odor heat exchange condenser is provided with an electromagnetic valve and a bypass branch; and the bypass branch of the odor heat exchange condenser is provided with an electromagnetic valve.

9. The solid high-temperature aerobic fermentation reaction system according to claim 1, wherein in the test and control system, the temperature sensors are disposed on the water outlet pipeline and the water return pipeline of the hot water boiler; outputs of the temperature sensors are connected with the test and control system; the material temperature sensor is disposed in the aerobic fermentation reactor; an output of the material temperature sensor is connected with the test and control system; the material level sensors for confirming material positions are disposed on the loading and unloading conveying equipment, the feed port and the discharge port; and outputs of the material level sensors are connected with the test and control system.

10. An aerobic fermentation method based on the above solid high-temperature aerobic fermentation reaction system, comprising:
(1) a solid high-temperature aerobic fermentation reaction system is built, which comprises a solid high-temperature aerobic fermentation system, a boiler system, an odor and flue gas treatment system and a test and control system; the solid high-temperature aerobic fermentation system comprises 1 to X solid high-temperature aerobic fermentation reactors, and X is more than or equal to 1; each solid high-temperature aerobic fermentation reactor comprises an inclined horizontal drum, a feed side sealing cover labyrinth sealing device, a discharge side sealing cover labyrinth sealing device, a power supporting wheel set, a stirring and anti-sticking device and an integrated base; a water jacket is arranged outside the horizontal drum; the feed side is higher than the discharge side; the horizontal drum, the feed side sealing cover labyrinth sealing device and the discharge side sealing cover labyrinth sealing device form a closed fermentation space; a feed hole and an exhaust hole are formed in the upper part of the feed side sealing cover; an air inlet hole is formed in the upper part of the discharge side sealing cover; a discharge hole is formed in the lower part of the discharge side sealing cover; a discharge gate is installed on the discharge hole; the stirring and anti-sticking device is positioned in the horizontal drum which is disposed on the power supporting wheel set; the power supporting wheel set, the feed side sealing cover and the discharge side sealing cover are fixed to the integrated base to form a whole; the boiler system comprises a hot water boiler, a circulating water pump, a three-way electric regulation valve and an electromagnetic valve; the boiler system is connected with the jacket of the solid high-temperature aerobic fermentation reactor; the odor and flue gas treatment system comprises an odor heat exchange condenser, a flue gas heat exchange condenser, a biological deodorization filtering tower, an induced draft fan and an electromagnetic valve; the exhaust hole of the solid high-temperature aerobic fermentation reactor and a smoke vent of the hot water boiler are connected with the odor and flue gas treatment system; the test and control system is as follows: temperature sensors are installed on a water outlet pipeline and a water return pipeline of the hot water boiler; a material temperature sensor is disposed in the solid high-temperature aerobic fermentation reactor; material level sensors for confirming material positions are disposed on loading and unloading conveying equipment, a feed port and a discharge port; detection signals of the above sensors are input into an input end of a controller; and an output end of the controller controls the boiler system, the odor and flue gas treatment system, the solid high-temperature aerobic fermentation reactor and the external loading and unloading conveying equipment;
(2) the structure and the principle of the feed side sealing cover labyrinth sealing device are completely the same as those of the discharge side sealing cover labyrinth sealing device, and each of the structures is that a lining ring having a radial plane consistent with the horizontal drum is fixed to an inner wall of the drum at a certain distance from the end of the horizontal drum; the outer circumference of the lining ring and the inner diameter of the horizontal drum are consistent and are fixedly connected; a lining ring hood axially identical with the horizontal drum is fixedly installed on the inner circumference of the lining ring; correspondingly, two concentric sealing cover hoods are vertically welded on the inner side plane of the sealing cover: a sealing cover outer hood and a sealing cover inner hood; the sealing cover inner hood is positioned on the inner side of the sealing cover outer hood, the sealing cover outer hood is sleeved on the outer side of the end of the horizontal drum, and the sealing cover inner hood is sleeved between the inner wall of the horizontal drum and the lining ring hood; meanwhile, the following three heights are required to be consistent: the height of the lining ring hood, the height of the sealing cover inner hood and a distance from the lining ring to the end of the horizontal drum; waist-shaped hole grooves are disposed in a feed side sealing cover and a discharge side sealing cover; clearances from the feed side sealing cover and the discharge side sealing cover to the horizontal drum are adjusted by adjusting relative positions of the waist-shaped hole grooves in the feed side sealing cover and the discharge side sealing cover and an integrated base, so as to avoid material leakage from gaps among the feed side sealing cover, the discharge side sealing cover and both ends of the horizontal drum; the quantity of the inner hoods is increased at the inner sides of the sealing covers; correspondingly, the quantity of the ring hoods is increased at the inner side of the drum to increase the quantity of labyrinths, so as to increase the length of the labyrinths and reduce material leakage;
(3) according to the length of the horizontal drum, the stirring and anti-sticking device may be composed of one or more cage-shaped structures; when the horizontal drum is relatively short, the stirring and anti-sticking device may be composed of only one cage-shaped structure; when the horizontal drum is relatively long, the stirring and anti-sticking device may be composed of a plurality of cage-shaped structures; each of the cage-shaped structures is composed of two coaxial supporting plates and a plurality of shoveling plates; the supporting plates are circular rings, and both ends of each of the plurality of shoveling plates are respectively connected and fixed with the two coaxial supporting plates; correspondingly, contact blocks are disposed on the inner wall of the horizontal drum; the axis of the cage-shaped structure is at a side of the axis of the horizontal drum, and does not coincide with the axis of the horizontal drum; namely, the cage-shaped structure is installed in a mode of deviating from the axis in the horizontal drum;
(4) the water outlet pipeline of the hot water boiler is connected to the input end of the three-way electric regulation valve; two output ends of the three-way electric regulation valve are respectively connected with an in-parallel solid high-temperature aerobic fermentation reactor water inlet flange through the water outlet pipeline; an electromagnetic valve is connected to the water outlet pipeline of each solid high-temperature aerobic fermentation reactor; the water outlet end of the electromagnetic valve is connected with the water return pipeline of the hot water boiler; the water return pipeline is provided with a circulating water pump to enable circulating water to form a loop;
(5) the solid high-temperature aerobic fermentation reactor exhaust hole is connected with the heat exchange air inlet of the odor heat exchange condenser through the pipeline; the heat exchange air outlet of the odor heat exchange condenser is connected with the input end of the induced draft fan through the pipeline, and the output end of the induced draft fan is connected with the air inlet of the biological deodorization filtering tower through the air inlet pipeline; a temperature sensor is installed on a main-path air inlet pipeline of the biological deodorization filtering tower; odor exhausted by the solid high-temperature aerobic fermentation reactor is cooled by the odor heat exchange condenser, absorbed and converted by the biological deodorization filtering tower, and is discharged after reaching the standard; the air inlet of the odor heat exchange condenser is connected with atmosphere, and an air outlet is connected with the solid high-temperature aerobic fermentation reactor air inlet hole; after cold air is heated by the odor heat exchange condenser, the solid high-temperature aerobic fermentation reactor is aerated through the induced draft fan; the smoke vent of the hot water boiler is connected with the heat exchange air inlet of the flue gas heat exchange condenser through the pipeline; the heat exchange air outlet of the flue gas heat exchange condenser is connected with the input end of the induced draft fan, and the output end of the induced draft fan is connected with the air inlet of the biological deodorization filtering tower; flue gas exhausted by the hot water boiler is cooled by the flue gas heat exchange condenser, absorbed and converted by the biological deodorization filtering tower, and is discharged after reaching the standard; the air inlet of the flue gas heat exchange condenser is connected with atmosphere, and an air outlet is connected with an air inlet of an air blower of the hot water boiler, so as to provide fresh hot air for the hot water boiler;
(6) the boiler system is started; the hot water boiler heats the circulating water; the circulating hot water enters an external water jacket of the solid high-temperature aerobic fermentation reactor, so that the solid high-temperature aerobic fermentation reactor is heated and the circulating water is heated to a set temperature suitable for high-temperature aerobic fermentation;
(7) external conveying equipment is started; fermentation raw materials and accessories, and a high-temperature aerobic bacteria are fed into the solid high-temperature aerobic fermentation reactor through the conveying equipment;
(8) during feeding, the control system starts all power driving devices at the same time to allow all power supporting wheel sets to rotate at the same time to drive a horizontal drum of the solid high-temperature aerobic fermentation reactor to rotate forwards; by virtue of the action of the stirring and anti-sticking device in the solid high-temperature aerobic fermentation reactor, fermentation raw materials are conveyed to the discharge side, and organic waste is shoveled up and dropped down so that the organic waste is fully stirred and mixed with oxygen, thereby enlarging the contact area of the fermentation raw materials and the oxygen;
(9) the boiler and the odor and flue gas treatment system are started at the same time; odor exhausted by the solid high-temperature aerobic fermentation reactor is cooled by the odor heat exchange condenser, then is conveyed to the biological deodorization filtering tower for absorption and conversion and is discharged into the atmosphere through the exhaust port of the biological deodorization filtering tower after reaching the standard; flue gas exhausted by the hot water boiler exchanges heat through the flue gas heat exchange condenser, is led to the biological deodorization filtering tower through the induced draft fan, then is absorbed and converted through the biological deodorization filtering tower and is discharged into the atmosphere through the exhaust port of the biological deodorization filtering tower after reaching the standard; meanwhile, fresh air heated by the flue gas heat exchange condenser is blasted into hot water boiler through an air blower of the hot water boiler to provide fresh hot air for the hot water boiler; condensed water produced by heat exchange between hot odor and flue gas and cold air in the odor heat exchange condenser and the flue gas heat exchange condenser is drained into a natural ditch through the odor heat exchange condenser and the flue gas heat exchange condenser via pipelines;
(10) when the amount of organic waste raw materials which are conveyed into the solid high-temperature aerobic fermentation reactor achieves the requirement, the control system controls to stop feeding;
(11) in the high-temperature aerobic fermentation reaction process, the control system automatically controls the opening of the circulating water three-way electric regulation valve according to the temperatures of the materials in the solid high-temperature aerobic fermentation reactors, so that the temperatures of the fermentation materials are stabilized at a set temperature all the time; when the temperature of the material in the solid high-temperature aerobic fermentation reactor of the first fermentation object is less than the set value, the opening of the three-way electric regulation valve in this loop is 100%, and the openings in the circulating water loops of other solid high-temperature aerobic fermentation reactors are 0; when the temperature of the material in the solid high-temperature aerobic fermentation reactor of the first fermentation object is close to the set value, the control system controls to turn on the electromagnetic valve in the circulating water loop of the solid high-temperature aerobic fermentation reactor of the second fermentation object, and the three-way electric regulation valve performs PID regulation to allow part of the hot circulating water to flow through the water jacket of the second solid high-temperature aerobic fermentation reactor, so that the second solid high-temperature aerobic fermentation reactor is heated under the condition of stabilizing the temperature of the material in the solid high-temperature aerobic fermentation reactor of the first fermentation object at the set value; because the aerobic fermentation process is a heat release process, along with the fermentation, the temperatures of the materials in the solid high-temperature aerobic fermentation reactors continuously rise up; when the temperature of the material in the solid high-temperature aerobic fermentation reactor of the first fermentation object is greater than the set value, the control system slows down or shuts off the heating of the hot water boiler; under the action of the circulating pump, the circulating water of the solid high-temperature aerobic fermentation reactor of the first fermentation object is mixed with the circulating water of the solid high-temperature aerobic fermentation reactor of the second fermentation object, resulting in that the temperature of the material in the solid high-temperature aerobic fermentation reactor of the first fermentation object is reduced, and the temperature of the material in the solid high-temperature aerobic fermentation reactor of the second fermentation object is increased; the three-way electric regulation valve and the electromagnetic valve are coordinately controlled by the control system to convey fermentation reaction heat of the previous solid high-temperature aerobic fermentation reactor and heat generated by heating of the hot water boiler to the second or Xth solid high-temperature aerobic fermentation reactor, so that the temperatures of the materials in the solid high-temperature aerobic fermentation reactors may be stabilized at the set value, and the heat energy generated by the fermentation reaction may be recycled;
(12) in an aerobic fermentation reaction process, the control system controls the power driving device of the solid high-temperature aerobic fermentation reactor to operate in a periodic intermittent operation manner of backward rotation-stop-backward rotation-stop . . . according to a detected temperature of the fermentation raw material; for shoveling plates of the stirring and anti-sticking device, during rotation of the drum, the stirring and anti-sticking device drives the materials at the bottom of the horizontal drum to move upwards, and the materials are separated from the shoveling plates under the action of the gravity of the materials and are thrown away and dropped back to the bottom of the horizontal drum, so as to achieve stirring and air contact effects; by virtue of the action of the spiral shoveling plates in the solid high-temperature aerobic fermentation reactor, the backward rotating drum shovels up the materials and conveys the fermentation raw materials to the feed side, so that the fermentation materials may not be compacted on the discharge side sealing cover; meanwhile, the fermentation raw materials may not be adhered to the inner wall of the drum of the solid high-temperature aerobic fermentation reactor, and the energy consumption caused by stirring and heat conduction is minimized;
(13) when detecting that the odor temperature detected by the temperature sensor installed on the main-path air inlet pipeline of the biological deodorization filtering tower is more than 40° C., the control system turns on the electromagnetic valves on the air inlet pipeline of the odor heat exchange condenser and turns off the electromagnetic valves of the bypass branches to allow the odor entering the biological deodorization filtering tower to be cooled by the odor heat exchange condenser; when detecting that the odor temperature detected by the temperature sensor installed on the main-path air inlet pipeline of the biological deodorization filtering tower is less than 15° C., the control system turns off the electromagnetic valves on the air inlet pipeline of the odor heat exchange condenser and turns on the electromagnetic valves of the bypass branches to forbid the odor to enter the odor heat exchange condenser for cooling; therefore, the biological deodorization filtering tower works in a temperature range between 15° C. and 40° C., so as to guarantee the deodorization effect and prevent dormancy or death of microorganisms in the biological deodorization filtering tower;
(14) when one solid high-temperature aerobic fermentation reactor completes the high-temperature aerobic fermentation reaction, the control system controls to turn off electromagnetic valves at the front ends of the power driving device and a water inlet pipeline of the water jacket of the solid high-temperature aerobic fermentation reactor, and controls to turn on a discharge gate at the same time; then the control system controls the power driving device to continuously rotate forwards to discharge part of old fermentation materials to the next working procedure for treatment through external conveying equipment; and
(15) the above steps are repeated so that the biological fermentative degradation reaction of the organic waste is circulated at high speed.
